(19) United States
(12) Patent Application Publication
(10) Pub. No.: US 2015/0048007 A1
(43) Pub. Date: Feb. 19, 2015

(54) MULTIVALENT MINERAL CATION TOLERANT ALKALI SYSTEM FOR CHEMICAL EOR

(71) Applicant: Board of Regents, The University of Texas System, Austin, TX (US)

(72) Inventors: Upali P. Weerasooriya, Austin, TX (US); Gary A. Pope, Cedar Park, TX (US); Kishore Mohanty, Austin, TX (US); Himanshu Sharma, Austin, TX (US)

(21) Appl. No.: 14/461,068

(22) Filed: Aug. 15, 2014

Related U.S. Application Data
(60) Provisional application No. 61/866,451, filed on Aug. 15, 2013.

(51) Int. Cl. C09K 8/58; C10G 1/04

(52) U.S. Cl. CPC C09K 8/58; C10G 1/045
USPC 208/390; 507/273

(57) ABSTRACT

Provided herein are, inter alia, compositions and methods for enhanced oil recovery in the presence of multivalent mineral cations. The aqueous and emulsion compositions provided herein include a boron oxygenate and may be useful for the recovery of unrefined petroleum materials from mineral-bearing reservoirs.

### CROSS-REFERENCE TO RELATED APPLICATIONS

This application claims the benefit of U.S. Provisional Application No. 61/866,451 filed Aug. 15, 2013, which is hereby incorporated in its entirety and for all purposes.

### BACKGROUND OF THE INVENTION

Enhanced Oil Recovery (abbreviated EOR) refers to techniques for increasing the amount of unrefined petroleum, or crude oil, which may be extracted from an oil reservoir (e.g. an oil field). Using EOR, 40-60% of the reservoir's original oil can typically be extracted compared with only 20-40% using primary and secondary recovery (e.g. by water injection or natural gas injection). Enhanced oil recovery may also be referred to as improved oil recovery or tertiary recovery (as opposed to primary and secondary recovery).

Enhanced oil recovery may be achieved by a variety of methods including miscible gas injection (which includes carbon dioxide flooding), chemical injection (which includes polymer flooding, alkaline flooding and surfactant flooding or any combination thereof), microbial injection, or thermal recovery (which includes cyclic steam, steam flooding, and fire flooding) or a combination of different injection methods (e.g. chemical injection and gas injection). The injection of various chemicals during chemical EOR, usually as dilute aqueous solutions, has been used to improve oil recovery. Injection of alkaline or caustic solutions into reservoirs with oil that has organic acids naturally occurring in the oil (also referred to herein as “unrefined petroleum acids”) will result in the production of soap that may lower the interfacial tension enough to increase production. Injection of a dilute solution of a water soluble polymer to increase the viscosity of the injected water can increase the amount of oil recovered from geological formations. Aqueous solutions of surfactants such as petroleum sulfonates may be injected to lower the interfacial tension or capillary pressure that impedes oil droplets from moving through a reservoir. Special formulations of oil, water and surfactant microemulsions, have also proven useful. Application of these methods is usually limited by the cost of the chemicals and their adsorption and loss onto the rock of the oil containing formation.

Some unrefined petroleum contains carboxylic acids having, for example, C₁₁ to C₂₀ alkyl chains, including napthenic acid mixtures (also referred to herein as “unrefined petroleum acids”). The recovery of such “reactive” oils may be performed using alkali agents (e.g. NaOH, Na₂CO₃) in a surfactant composition. The alkali reacts with the acid (unrefined petroleum acid) in the reactive oil to form soap. These soaps serve as an additional source of surfactants enabling the use of much lower level of surfactants initially added to affect enhanced oil recovery (EOR). However, when the available water supply is hard, the added alkali causes precipitation of cations, such as multivalent mineral cations (e.g. Ca⁺² or Mg⁺²). In order to prevent such precipitation a somewhat expensive chelant such as EDTA may be required in the surfactant composition or a water softening processes may be used. Applicants have developed surfactant formulations (e.g. alkoxy carboxylate surfactants), which can be effectively used for enhanced oil recovery in the absence of alkali agents. These surfactant formulations are particularly effective at neutral pH. However, at low pH (e.g. pH 7 or lower) the non-alkaline surfactant formulations are associated with higher adsorption of the surfactant to the rock. At a pH above 7 (e.g. 8, 9, 10, or 11), on the other hand, the surfactant adsorption can only be significantly reduced for these surfactant formulations by addition of alkaline agents. However, where the rock surface of the reservoir contains sulfate minerals (e.g. gypsum or anhydrite), the above-mentioned precipitation of multivalent mineral cations (e.g. Ca⁺² or Mg⁺²) due to the presence of alkali agents (e.g. sodium carbonate) reduces the pH and the surfactant solubility and therefore, the efficiency of the oil recovery process. Thus, there is a need in the art, particularly where the oil reservoir includes sulfate minerals, for an alkali agent capable of stably propagating a pH where the adsorption of surfactant to the rock is minimized without causing precipitation of multivalent mineral cations such as Ca⁺² or Mg⁺² from the rock surface.

The compositions and methods provided herein overcome these and other needs in the art. Therefore, the methods and compositions provided are particularly useful for cost effective enhanced oil recovery using chemical injection.

### BRIEF SUMMARY OF THE INVENTION

In one aspect, an aqueous composition is provided including water, a surfactant, a boron oxygenate and a multivalent mineral cation.

In another aspect, an aqueous composition is provided herein including water, a co-solvent, a boron oxygenate and a multivalent mineral cation.

In another aspect, an emulsion composition is provided including an unrefined petroleum, water, a surfactant, a boron oxygenate and a multivalent mineral cation.

In another aspect, an emulsion composition is provided including an unrefined petroleum, water, a co-solvent, a boron oxygenate and a multivalent mineral cation.

In another aspect, an aqueous composition including water, a hydrolyzed or partially hydrolyzed viscosity enhancing water soluble polymer and a boron oxygenate at a pH of at least about 9.

In another aspect, a method of displacing an unrefined petroleum material in contact with a solid material is provided. The method includes contacting an unrefined petroleum material with an aqueous composition as provided herein. The unrefined petroleum material is in contact with a solid material comprising a mineral, wherein water dissolves multivalent mineral cations from the mineral. The unrefined petroleum material is allowed to separate from the solid material thereby displacing the unrefined petroleum material in contact with the solid material.

In another aspect, a method of converting an unrefined petroleum acid into a surfactant is provided. The method includes contacting a petroleum material with an aqueous composition as provided herein, thereby forming an emulsion in contact with the petroleum material. The unrefined petroleum acid within the unrefined petroleum material is allowed to enter into the emulsion, thereby converting the unrefined petroleum acid into a surfactant.

### BRIEF DESCRIPTION OF THE DRAWINGS

FIG. 1: Effluent pH on sodium metaborate injection in a sandstone core with gypsum. 3% NaBO2 injection in sandstone core with gypsum at 55° C. at 0.89 ft/day, injection pH=10.74.

FIG. 2: Pressure drop data for sodium metaborate injection (0.89 ft/day=0.040 mL/min)

FIG. 3: Experimental setup.

FIG. 4: Transport of sodium metaborate in a carbonate core. The calcium and sulfate concentration in the effluent shows the presence of gypsum in the core.

FIG. 5: Injecting sodium metaborate in the same carbonate core (results presented in FIG. 4) but with the residence time of 15 days.

FIG. 6: Oil recovery of oil #1 (viscosity 3 cp) at 55° C. using a tertiary ASP (0.6% C₁₃-13PO sulfate, 0.4% C₁₉₋₂₃ IOS, 1% IBA (isobutyl alcohol), 3.75% NaBO₂ (sodium metaborate) and 2,500 ppm Flopaam 3330S) coreflood with sodium metaborate (first polymer slug: 2,000 ppm Flopaam 3330S with 1% NaBO₂; second polymer slug: 800 ppm Flopaam 3330S). Residence time for ASP coreflood: 1 day; Box A indicates ASP Slug with 39,000 ppm; Box B indicates polymer drive 1 with 11,000 ppm; Box C indicates polymer drive 2 with 1,600 ppm.

FIG. 7: Pressure drop data for the ASP coreflood of oil #1 as described in FIG. 6 (1.1 ft/day=0.046 mL/min).

### DETAILED DESCRIPTION OF THE INVENTION

### 1. Definitions

The abbreviations used herein have their conventional meaning within the chemical and biological arts.

Where substituent groups are specified by their conventional chemical formulae, written from left to right, they equally encompass the chemically identical substituents that would result from writing the structure from right to left, e.g., —CH₂O— is equivalent to —OCH₂—.

The term “alkyl,” by itself or as part of another substituent, means, unless otherwise stated, a straight (i.e. unbranched) or branched chain, which may be fully saturated, mono- or polyunsaturated and can include di- and multivalent radicals, having the number of carbon atoms designated (i.e. C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butyryl, and the higher homologs and isomers. Alkyl groups, which are limited to hydrocarbon groups, are termed “homoalkyl”. An alkoxy is an alkyl attached to the remainder of the molecule via an oxygen linker (—O—).

The term “alkylene” by itself or as part of another substituent means a divalent radical derived from an alkyl, as exemplified, but not limited, by —CH₂CH₂CH₂CH₂—, and further includes those groups described below as “heteroalkylene.” Typically, an alkyl (or alkylene) group will have from 1 to 24 carbon atoms, with those groups having 10 or fewer carbon atoms being preferred in the present invention. A “lower alkyl” or “lower alkylene” is a shorter chain alkyl or alkylene group, generally having eight or fewer carbon atoms.

The term “heteroalkyl,” by itself or in combination with another term, means, unless otherwise stated, a stable straight or branched chain or combinations thereof, consisting of at least one carbon atom and at least one heteroatom selected from the group consisting of O, N, P, Si and S, and wherein the nitrogen and sulfur atoms may optionally be oxidized and the nitrogen heteroatom may optionally be quaternized. The heteroatom(s) O, N, P and S and Si may be placed at any interior position of the heteroalkyl group or at the position at which the alkyl group is attached to the remainder of the molecule. Examples include, but are not limited to, —CH₂—CH₂—O—CH₃, —CH₂—CH₂—NH—CH₃, —CH₂—CH₂—N(CH₃)—CH₃, —CH₂—S—CH₂—CH₃, —CH₂—CH₂, —S(O)—CH₃, —CH₂—CH₂—S(O)₂—CH₃, —CH═CH—O—CH₃, —Si(CH₃)₃, —CH₂—CH═N—OCH₃, —CH═CH—N(CH₃)—CH₃, —O—CH₃, —O—CH₂, —CH₃, and —CN. Up to two heteroatoms may be consecutive, such as, for example, —CH₂—NH—OCH₃. Similarly, the term “heteroalkylene” by itself or as part of another substituent means a divalent radical derived from heteroalkyl, as exemplified, but not limited by, —CH₂—CH₂—S—CH₂—CH₂— and —CH₂—S—CH₂—CH₂—NH—CH₂—. For heteroalkylene groups, heteroatoms can also occupy either or both of the chain termini (e.g., alkyleneoxy, alkylenedioxy, alkyleneamino, alkylenediamino, and the like). Still further, for alkylene and heteroalkylene linking groups, no orientation of the linking group is implied by the direction in which the formula of the linking group is written. For example, the formula —C(O)₂R′— represents both —C(O)₂R′— and —R′C(O)₂—.

The terms “cycloalkyl” and “heterocycloalkyl,” by themselves or in combination with other terms, represent, unless otherwise stated, cyclic versions of “alkyl” and “heteroalkyl”, respectively. Additionally, for heterocycloalkyl, a heteroatom can occupy the position at which the heterocycle is attached to the remainder of the molecule. Examples of cycloalkyl include, but are not limited to, cyclopropyl, cyclobutyl, cyclopentyl, cyclohexyl, 1-cyclohexenyl, 3-cyclohexenyl, cycloheptyl, and the like. Examples of heterocycloalkyl include, but are not limited to, 1-(1,2,5,6-tetrahydropyridyl), 1-piperidinyl, 2-piperidinyl, 3-piperidinyl, 4-morpholinyl, 3-morpholinyl, tetrahydrofuran-2-yl, tetrahydrofuran-3-yl, tetrahydrothien-2-yl, tetrahydrothien-3-yl, 1-piperazinyl, 2-piperazinyl, and the like. A “cycloalkylene” and a “heterocycloalkylene,” alone or as part of another substituent means a divalent radical derived from a cycloalkyl and heterocycloalkyl, respectively.

The term “aryl” means, unless otherwise stated, a polyunsaturated, aromatic, hydrocarbon substituent which can be a single ring or multiple rings (preferably from 1 to 3 rings) which are fused together (i.e. a fused ring aryl) or linked covalently. A fused ring aryl refers to multiple rings fused together wherein at least one of the fused rings is an aryl ring. The term “heteroaryl” refers to aryl groups (or rings) that contain from one to four heteroatoms selected from N, O, and S, wherein the nitrogen and sulfur atoms are optionally oxidized, and the nitrogen atom(s) are optionally quaternized. Thus, the term “heteroaryl” includes fused ring heteroaryl groups (i.e. multiple rings fused together wherein at least one of the fused rings is a heteroaromatic ring). A 5,6-fused ring heteroarylene refers to two rings fused together, wherein one ring has 5 members and the other ring has 6 members, and wherein at least one ring is a heteroaryl ring. Likewise, a 6,6-fused ring heteroarylene refers to two rings fused together, wherein one ring has 6 members and the other ring has 6 members, and wherein at least one ring is a heteroaryl ring. And a 6,5-fused ring heteroarylene refers to two rings fused together, wherein one ring has 6 members and the other ring has 5 members, and wherein at least one ring is a heteroaryl ring. A heteroaryl group can be attached to the remainder of the molecule through a carbon or heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below. An “arylene” and a “heteroarylene,” alone or as part of another substituent means a divalent radical derived from an aryl and heteroaryl, respectively.

Where a substituent of a compound provided herein is “R-substituted” (e.g. R⁷-substituted), it is meant that the substituent is substituted with one or more of the named R groups (e.g. R⁷) as appropriate. In embodiments, the substituent is substituted with only one of the named R groups.

The symbol “ [symbol] ” denotes the point of attachment of a chemical moiety to the remainder of a molecule or chemical formula.

Each R-group as provided in the formulae provided herein can appear more than once. Where an R-group appears more than once each R group can be optionally different.

The term “contacting” as used herein, refers to materials or compounds being sufficiently close in proximity to react or interact. For example, in methods of contacting a hydrocarbon material (i.e. unrefined petroleum material)-bearing formation and/or a well bore, the term “contacting” includes placing an aqueous composition (e.g. chemical, surfactant or polymer) within a hydrocarbon material-bearing formation using any suitable manner known in the art (e.g., pumping, injecting, pouring, releasing, displacing, spotting or circulating the chemical into a well, well bore or hydrocarbon-bearing formation).

The terms “unrefined petroleum” and “crude oil” are used interchangeably and in keeping with the plain ordinary usage of those terms. “Unrefined petroleum” and “crude oil” may be found in a variety of petroleum reservoirs (also referred to herein as a “reservoir,” “oil field deposit” “deposit” and the like) and in a variety of forms including oleaginous materials, oil shales (i.e. organic-rich fine-grained sedimentary rock), tar sands, light oil deposits, heavy oil deposits, and the like. “Crude oils” or “unrefined petroleums” generally refer to a mixture of naturally occurring hydrocarbons (i.e. unrefined petroleum material) that may be refined into diesel, gasoline, heating oil, jet fuel, kerosene, and other products called fuels or petrochemicals. Crude oils or unrefined petroleums are named according to their contents and origins, and are classified according to their per unit weight (specific gravity). Heavier crudes generally yield more heat upon burning, but have lower gravity as defined by the American Petroleum Institute (API) and market price in comparison to light (or sweet) crude oils. Crude oil may also be characterized by its Equivalent Alkane Carbon Number (EACN).

Crude oils vary widely in appearance and viscosity from field to field. They range in color, odor, and in the properties they contain. While all crude oils are mostly hydrocarbons, the differences in properties, especially the variation in molecular structure, determine whether a crude oil is more or less easy to produce, pipeline, and refine. The variations may even influence its suitability products and the quality of those products. Crude oils are roughly classified into three groups, according to the nature of the hydrocarbons they contain. (i) Paraffin based crude oils contain higher molecular weight paraffins, which are solid at room temperature, but little or no asphaltic (bituminous) matter. They can produce high-grade lubricating oils. (ii) Asphaltene based crude oils contain large proportions of asphaltic matter, and little or no paraffin. Some are predominantly naphthenes and so yield lubricating oils that are sensitive to temperature changes than the paraffin-based crudes. (iii) Mixed based crude oils contain both paraffin and naphthenes, as well as aromatic hydrocarbons. Most crude oils fit this latter category.

“Unrefined petroleum acids” as referred to herein are carboxylic acids contained in active petroleum material (reactive heavy crude oil). The unrefined petroleum acids contain C₁₁ to C₂₀ alkyl chains, including napthenic acid mixtures. The recovery of such “reactive” oils may be performed using alkali (e.g. NaOH or Na₂CO₃) in a surfactant composition. The alkali reacts with the acid in the reactive oil to form soap in situ. These in situ generated soaps serve as a source of surfactants enabling efficient oil recovery from the reservoir as well as heavy crude oil transport.

“Reactive” or “active” heavy crude oil as referred to herein is heavy crude oil containing natural organic acidic components (also referred to herein as unrefined petroleum acid) or their precursors such as esters or lactones. These reactive heavy crude oils can generate soaps (carboxylates, surfactants) when reacted with alkali or an organic base. More terms used interchangeably for heavy crude oil throughout this disclosure are hydrocarbon material or reactive petroleum material or unrefined petroleum material. An “oil bank” or “oil cut” as referred to herein, is the heavy crude oil that does not contain the injected chemicals and is pushed by the injected fluid during an enhanced oil recovery process.

Terms used interchangeably for crude oil throughout this disclosure are “hydrocarbon material” or “unrefined petroleum material”. An “oil bank” or “oil cut” as referred to herein, is the crude oil that does not contain the injected chemicals and is pushed by the injected fluid during an enhanced oil recovery process.

The term “polymer” refers to a molecule having a structure that essentially includes the multiple repetitions of units derived, actually or conceptually, from molecules of low relative molecular mass. In embodiments, the polymer is an oligomer.

The term “bonded” refers to having at least one of covalent bonding, hydrogen bonding, ionic bonding, Van Der Waals interactions, pi interactions, London forces or electrostatic interactions.

The term “productivity” as applied to a petroleum or oil well refers to the capacity of a well to produce hydrocarbons (e.g. unrefined petroleum material); that is, the ratio of the hydrocarbon flow rate to the pressure drop, where the pressure drop is the difference between the average reservoir pressure and the flowing bottom hole well pressure (i.e., flow per unit of driving force).

The term “oil solubilization ratio” is defined as the volume of oil solubilized divided by the volume of surfactant in microemulsion. All the surfactant is presumed to be in the microemulsion phase. The oil solubilization ratio is applied for Winsor type I and type III behavior. The volume of oil solubilized is found by reading the change between initial aqueous level and excess oil (top) interface level. The oil solubilization ratio is calculated as follows:

$${σ}_{o} = \frac{{V}_{o}}{{V}_{s}} ,$$

wherein
σₒ=oil solubilization ratio;
Vₒ=volume of oil solubilized;
Vₛ=volume of surfactant.

The term “water solubilization ratio” is defined as the volume of water solubilized divided by the volume of surfactant in microemulsion. All the surfactant is presumed to be in the microemulsion phase. The water solubilization ratio is applied for Winsor type III and type II behavior. The volume of water solubilized is found by reading the change between initial aqueous level and excess water (bottom) interface level. The water solubilization parameter is calculated as follows:

$${σ}_{w} = \frac{{V}_{w}}{{V}_{s}} ,$$

wherein
σ_{w}=water solubilization ratio;
V_{w}=volume of water solubilized.

The optimum solubilization ratio occurs where the oil and water solubilization ratios are equal. The coarse nature of phase behavior screening often does not include a data point at optimum, so the solubilization ratio curves are drawn for the oil and water solubilization ratio data and the intersection of these two curves is defined as the optimum. The following is true for the optimum solubilization ratio:

σₒ=σ_{w}=σ*;
σ*=optimum solubilization ratio.

The term “solubility” or “solubilization” in general refers to the property of a solute, which can be a solid, liquid or gas, to dissolve in a solid, liquid or gaseous solvent thereby forming a homogenous solution of the solute in the solvent. Solubility occurs under dynamic equilibrium, which means that solubility results from the simultaneous and opposing processes of dissolution and phase joining (e.g. precipitation of solids). The solubility equilibrium occurs when the two processes proceed at a constant rate. The solubility of a given solute in a given solvent typically depends on temperature. For many solids dissolved in liquid water, the solubility increases with temperature. In liquid water at high temperatures, the solubility of ionic solutes tends to decrease due to the change of properties and structure of liquid water. In more particular, solubility and solubilization as referred to herein is the property of oil to dissolve in water and vice versa.

“Viscosity” refers to a fluid's internal resistance to flow or being deformed by shear or tensile stress. In other words, viscosity may be defined as thickness or internal friction of a liquid. Thus, water is “thin”, having a lower viscosity, while oil is “thick”, having a higher viscosity. More generally, the less viscous a fluid is, the greater its ease of fluidity.

The term “salinity” as used herein, refers to concentration of salt dissolved in a aqueous phases. Examples for such salts are without limitation, sodium chloride, magnesium and calcium sulfates, and bicarbonates. In more particular, the term salinity as it pertains to the present invention refers to the concentration of salts in brine and surfactant solutions.

The term “aqueous solution or aqueous formulation” refers to a solution in which the solvent is water. The term “emulsion, emulsion solution or emulsion formulation” refers to a mixture of two or more liquids, which are normally immiscible. A non-limiting example for an emulsion is a mixture of oil and water.

A “alkali agent” as provided herein is used according to its conventional meaning and refers any basic, ionic salts of alkali metals or alkaline earth metals. Examples of alkali agents include, but are not limited to, sodium hydroxide, sodium carbonate, sodium silicate, sodium metaborate, and EDTA tetrasodium salt. Alkali agents as provided herein are typically capable of reacting with an unrefined petroleum acid (e.g. the acid in crude oil (reactive oil)) to form soap (a surfactant salt of a fatty acid) in situ. These in situ generated soaps serve as a source of surfactants causing a reduction of the interfacial tension of the oil in water emulsion, thereby reducing the viscosity of the emulsion.

A “co-solvent” refers to a compound having the ability to increase the solubility of a solute in the presence of an unrefined petroleum acid. In embodiments, the co-solvents provided herein have a hydrophobic portion (alkyl or aryl chain), a hydrophilic portion (e.g. an alcohol) and optionally an alkoxy portion. Co-solvents as provided herein include alcohols (e.g. C₁-C₆ alcohols, C₁-C₆ diols), alkoxy alcohols (e.g. C₁-C₆ alkoxy alcohols, C₁-C₆ alkoxy diols, phenyl alkoxy alcohols), glycol ether, glycol and glycerol.

A “microemulsion” as referred to herein is a thermodynamically stable mixture of oil, water and surfactants that may also include additional components such as the compounds provided herein including embodiments thereof, electrolytes, alkali and polymers. In contrast, a “macroemulsion” as referred to herein is a thermodynamically unstable mixture of oil and water that may also include additional components. The emulsion composition provided herein may be an oil-in-water emulsion, wherein the surfactant forms aggregates (e.g. micelles) where the hydrophilic part of the surfactant molecule contacts the aqueous phase of the emulsion and the lipophilic part contacts the oil phase of the emulsion. Thus, in embodiments, the surfactant forms part of the aqueous part of the emulsion. And in embodiments, the surfactant forms part of the oil phase of the emulsion. In yet another embodiment, the surfactant forms part of an interface between the aqueous phase and the oil phase of the emulsion.

### 2. Compositions

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not limit the scope of the invention.

Provided herein, inter alia, are aqueous compositions and methods of using the same for a variety of applications including enhanced oil recovery. In one aspect, the aqueous composition provided herein includes water, a surfactant (or a combination of multiple surfactants), a boron oxygenate (i.e. a basic or alkali chemical compound containing boron and oxygen) and a multivalent mineral cation (i.e. a divalent or trivalent cation derived from a mineral). The aqueous composition may further include a co-solvent.

In another aspect, the aqueous composition provided herein includes water, a co-solvent, a boron oxygenate and a multivalent mineral cation. The aqueous composition may further include a surfactant.

In another aspect, an aqueous composition is provided including water, a hydrolyzed or partially hydrolyzed viscosity enhancing water soluble polymer and a boron oxygenate, where the aqueous composition has a pH of at least about 9 (e.g. about 10). The partially hydrolyzed viscosity enhancing water soluble polymer may be hydrolyzed or partially hydrolyzed polyacrylamide (HPAM).

The aqueous compositions can be used with broad oil concentrations, at a wide range of salinities and are surprisingly effective for oil recovery from mineral-containing reservoirs (e.g. reservoirs containing minerals wherein, upon contact with water, a multivalent mineral cation is dissolved as described herein). The aqueous compositions provided herein may be functional at high reservoir temperatures (e.g. about 90° C. to about 120° C., or about 100° C. to about 120° C., or about 110° C. to about 120° C.) and/or particularly at alkaline pH (e.g. pH 9 or higher, or about pH 10). The boron oxygenate included in the aqueous composition may prevent surfactant precipitation and minimize surfactant adsorption to solid reservoir material (e.g. rock). Thus, using the aqueous composition provided herein, the organic acids in the oil (heavy oil/unrefined petroleum) may be readily available (i.e. mobilized), even at high pH (e.g. at least about 9 or about 10) to form soap that may lower the interfacial tension enough to increase oil production from the well. The compositions provided herein are useful for the recovery of active and non-active crude oils. Thus, in embodiments, the aqueous compositions and emulsions provided herein provide an elevated pH (e.g. above about 9.0 or 9.5, or about 10) conducive for soap formation in active oils where minerals and/or multivalent mineral cations are present.

In embodiments, the aqueous composition is within a petroleum reservoir. In embodiments, the aqueous composition is in contact with a mineral. The multivalent mineral cation may be derived from the mineral. Thus, in embodiments, water dissolves the multivalent mineral cation from the mineral. The mineral may be a sulfate mineral, such as gypsum, anhydrite, barite or magnesium sulfate. A “sulfate mineral” as provided herein refers to a mineral, which includes the sulfate ion SO₄²⁻ within its structure. Non-limiting examples of sulfate minerals include anhydrous sulfates such as barite (BaSO₄), celestite (SrSO₄), anglesite (PbSO₄), anhydrite (CaSO₄), and hanksite (Na₂K(SO₄)₉(CO₃)₂Cl); and hydroxide or hydrous sulfates such as gypsum (CaSO₄2H₂O), chalcanthite (CuSO₄5H₂O), kieserite (MgSO₄.H₂O), starkeyite (MgSO₄.4H₂O), hexahydrite (MgSO₄.6H₂O), epsomite (MgSO₄.7H₂O), meridianiite (MgSO₄.11H₂O), melanterite (FeSO₄.7H₂O), antlerite (Cu3SO₄(OH)₄), brochantite (Cu₄SO₄(OH)₆), alunite (KAl₃(SO₄)₂(OH)₆), and jarosite (KFe₃(SO₄)₂(OH)₆). In embodiments, the sulfate mineral is gypsum. In embodiments, the sulfate mineral (e.g. gypsum) forms part of the solid reservoir material (e.g. rock). In embodiments, the mineral (e.g. sulfate mineral) forms part of the solid reservoir material and the aqueous composition provided herein including embodiments thereof.

The multivalent mineral cation may be an alkaline earth metal cation (i.e. a cation of beryllium (Be), magnesium (Mg), calcium (Ca), strontium (Sr), barium (Ba), or radium (Ra)). The multivalent mineral cation may be Fe³⁺, Ca²⁺, Mg²⁺, Sr²⁺, Ba²⁺ or Be²⁺.

The boron oxygenate typically forms boron oxyanions (anions of boron and oxygen combined) at a pH of at least about 9. Thus, the boron oxygenate alone or in combination with other alkali are used in the compositions an methods provided herein to achieve a pH of greater than about 9 (e.g. about 9.5 or about 10.0) The boron oxygenate may be a metaborate or a borax. In embodiments, the boron oxygenate is sodium metaborate. The term “sodium metaborate” as provided herein refers to the borate salt having the chemical formula NaBO₂4H₂O and in the customary sense, refers to CAS Registry No. 10555-76-7. In embodiments, the boron oxygenate is borax. Where the boron oxygenate is borax, the composition may further include sodium silicate, potassium hydroxide or sodium hydroxide. In embodiments, where the boron oxygenate is borax, the composition may further include sodium silicate.

In embodiments, the boron oxygenate is Borax, Sodium tetraborate decahydrate (Na₂B₄O₇.10H₂O), Borax pentahydrate (Na₂B₄O₇.5H₂O), Kernite (Na₂B₄O₇.4H₂O), Borax monohydrate (Na₂O.2B₂O₃.H₂O), Sodium metaborate tetrahydrate (NaBO₂.4H₂O or Na₂O.B₂O₃.8H₂O), Sodium metaborate dihydrate (NaBO₂.2H₂O or Na₂O.B₂O₃.4H₂O), Ezcurrite (2Na₂O.5.1B₂O₃.7H₂O), Auger's sodium borate/Nasinite (2Na₂O.5B₂O₃.5H₂O), Sodium pentaborate (Na₂O.5B₂O₃.10H₂O), Potassium metaborate (K₂O.B₂O₃.2.5H₂O), Potassium tetraborate (K₂O.2B₂O₃.8H₂O or 4H₂O), Auger's potassium pentaborate (2K₂O.5B₂O₃.5H₂O), Potassium pentaborate (K₂O.5B₂O₃.8H₂O), Lithium metaborate octahydrate (LiBO₂.8H₂O or Li₂O.B₂O₃.16H₂O), Lithium tetraborate trihydrate (Li₂O.2B₂O₃.3H₂O), Lithium pentaborate (Li₂O.5B₂O₃.10H₂O), Rubidium diborate (Rb₂O.2B₂O₃.5H₂O), Rubidium pentaborate (Rb₂O.5B₂O₃.8H₂O), Rubidium metaborate (Rb₂O.B₂O₃.3H₂O), Cesium Metaborate (Cs₂O.B₂O₃.7H₂O), Cesium diborate (Cs₂O.2B₂O₃.5H₂O), Cesium pentaborate (Cs₂O.5B₂O₃.8H₂O), Ammonium biborate ((NH₄)₂.2B₂O₃.4H₂O), Ammonium pentaborate ((NH₄)₂O.5B₂O₃.8H₂O), Larderellite, probably ((NH₄)₂O.5B₂O₃.4H₂O), Ammonioborite ((NH₄)₂O.5B₂O₃.5⅓H₂O), Kernite (Rasorite) (Na₂B₄O₂.4H₂O), Tincalconite (Mohavite) (Na₂B₄O₇.5H₂O), Borax (Tincal) (Na₂B₄O₇.10H₂O), Sborgite (Na₂B₁₀O₁₆.10H₂O), Ezcurrite (Na₄B₁₀O₁₇.7H₂O), Probertite (Kramerite) (NaCaB₅O₉.5H₂O), Ulxiete (Hayesine, Franklandite) (NaCaB₅O₉.8H₂O), Nobleite (CaB₆O₁₀.4H₂O), Gowerite (CaB₆O₁₀.5H₂O), Frolovite (Ca₂B₄O₈.7H₂O), Colemanite (Ca₂B₆O₁₁.5H₂O), Meyerhofferite (Ca₂B₆O₁₁.7H₂O), Inyoite (Ca₂B₆O₁₁.13H₂O), Priceite {(Pandermite) (Cryptomorphite)} (Ca₄B₁₀O₁₉.7H₂O), Tertschite (Ca₄B₁₀O₁₉.20H₂O), Ginorite (Ca₂B₁₄O₂₃.8H₂O), Pinnoite (MgB₂O₄.3H₂O), Paternoite (MgB₈O₁₃.4H₂O), Kurnakovite (Mg₂B₆O₁₁.15H₂O), Inderite (lesserite) (monoclinic) (Mg₂B₆O₁₁.15H₂O), Preobrazhenskite (Mg₃B₁₀O₁₈.4½H₂O), Hydroboracite (CaMgB₆O₁₁.6H₂O), Inderborite (CaMgB₆O₁₁.11H₂O), Kaliborite (Heintzite) (KMg₂B₁₁O₁₉.9H₂O), Larderellite ((NH₄)₂B₁₀O₁₆.4H₂O), Ammonioborite ((NH₄)₂B₁₀O₁₆5⅓H₂O), Veatchite (SrB₆O₁₀.2H₂O), p-Veatchite ((Sr,Ca)B₆O₁₀.2H₂O), Teepleite (Na₂B₂O₄.2Na₂Cl.4H₂O), Bandylite (CuB₂O₄.CuCl₂.4H₂O), Hilgardite (monocline) (3Ca₂B₆O₁₁.2CaCl₂.4H₂O), Parahilgardite (triclinic) (3Ca₂B₆O₁₁.2CaCl₂.4H₂O), Boracite (Mg₅B₁₄O₂₆MgCl₂), Fluoborite (Mg₃(BO₃)(F,OH)₃), Hambergite (Be₂(BO₃)(OH)), Sussexite ((Mn,Zn)(BO₂)(OH)), (Ascharite Camsellite) (Mg(BO₂)(OH)), Szaibelyite (Mg(BO₂)(OH)), Roweite ((Mn,Mg,Zn)Ca(BO₂)₂(OH)₂), Seamanite (Mn₃(PO₄)(BO₃).3H₂O), Wiserite (Mn₄B₂O₅(OH,Cl)₄), Luneburgite (Mg₃B₂(OH)₆(PO₄)₂.6H₂O), Cahnite (Ca₂B(OH)₄(AsO₄)), Sulfoborite (Mg₆H₄(BO₃)₄(SO₄)₂.7H₂O), Johachidolite (H₆Na₂Ca₃Al₄F₅B₆O₂₀), Boric Acid, Sassolite (H₃BO₃), Jeremejewite (Eichwaldite) (AlBO₃), Kotoite (Mg₃(BO₃)₂), Nordenskioldine (CaSn(BO₃)₂), Rhodizite, Warwickite ((Mg,Fe)₃TiB₂O₆), Ludwigite (Ferro-ludwegite, Vonsenite) ((Mg,Fe^{II})₂Fe^{III}BO₅), Paigeite ((Fe^{II},Mg)₂Fe^{III}BO₅), Pinakiolite (Mg₃Mn^{II}Mn₂^{III}B₂O₁₀), Axinite (2Al₂O₃.2(Fe,Mn)O.4CaO.H₂O.B₂O₃8SiO₂), Bakerite, Danburite (CaO.B₂O₃.2SiO₂), Datolite (2CaO.H₂O.B₂O₃.SiO₂), Dumortierite (8Al₂O₃.H₂OB₂O₃.6SiO₂), Grandidierite (11(Al,Fe,B)₂O₃.7(Mg,Fe,Ca)O.2(H,Na,K)_{2O}.7SiO₂), Homilite (2CaO.FeO.B₂O₃.2SiO₂), Howlite (4CaO.5H_{2O}.5B₂O₃.2SiO₂), Hyalotekite (16(Pb,Ba,Ca)O.F.2B₂O₃.2₄H₂O), Kornerupine, Manandonite (7Al₂O₃.2Li₂O.12H₂O.2B₂O₃.6SiO₂), Sapphirine, Searlesite (Na₂O.2H₂O.B₂O₃.4SiO₂), Serendibite (3Al₂O₃.2Ca.4MgO.B₂O₃.4SiO₂), or a combination thereof. The above boron oxygenates may be combined with other alkali or alkali agents (referred to herein interchangeably) (such as sodium silicate, potassium hydroxide or sodium hydroxide) to achieve the desired elevated pH level of at least about 9 (e.g. about 10).

The aqueous composition provided herein including embodiments thereof may include a surfactant or a combination of multiple surfactants (e.g. a plurality of surfactant types or a surfactant blend). The surfactant provided herein may be any appropriate surfactant useful in the field of enhanced oil recovery. In embodiments, the surfactant is a single surfactant type in the aqueous composition. In embodiments, the surfactant is a surfactant blend. A “surfactant blend” as provided herein is a mixture of a plurality of surfactant types. In embodiments, the surfactant blend includes a first surfactant type, a second surfactant type, or a third surfactant type. The first, second and third surfactant type may be independently different (e.g. anionic or cationic surfactants; or two cationic surfactant having a different hydrocarbon chain length but are otherwise the same). Thus, the aqueous composition may include a first surfactant, a second surfactant and a third surfactant, wherein the first surfactant is chemically different from the second and the third surfactant, and the second surfactant is chemically different from the third surfactant. Therefore, a person having ordinary skill in the art will immediately recognize that the terms “surfactant” and “surfactant type(s)” have the same meaning and can be used interchangeably. In embodiments, the surfactant is an anionic surfactant, a non-ionic surfactant, a zwitterionic surfactant or a cationic surfactant. In embodiments, the surfactant is an anionic surfactant, a non-ionic surfactant, or a cationic surfactant. In embodiments, the co-surfactant is a zwitterionic surfactant. “Zwitterionic” or “zwitterion” as used herein refers to a neutral molecule with a positive (or cationic) and a negative (or anionic) electrical charge at different locations within the same molecule. Examples for zwitterionics are without limitation betains and sultains.

The surfactant provided herein may be any appropriate anionic surfactant. In embodiments, the surfactant is an anionic surfactant. In embodiments, the anionic surfactant is an anionic surfactant blend. Where the anionic surfactant is an anionic surfactant blend the aqueous composition includes a plurality (i.e. more than one) of anionic surfactant types. In embodiments, the anionic surfactant is an alkoxy carboxylate surfactant, an alkoxy sulfate surfactant, an alkoxy sulfonate surfactant, an alkyl sulfonate surfactant, an aryl sulfonate surfactant or an olefin sulfonate surfactant. An “alkoxy carboxylate surfactant” as provided herein is a compound having an alkyl or aryl attached to one or more alkoxylene groups (typically —CH₂—CH(ethyl)-O—, —CH₂—CH(methyl)-O—, or —CH₂—CH₂—O—) which, in turn is attached to —COO⁻ or acid or salt thereof including metal cations such as sodium. In embodiments, the alkoxy carboxylate surfactant has the formula:

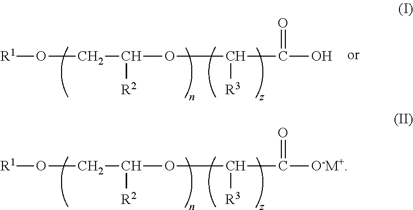

In formula (I) or (II) R¹ is substituted or unsubstituted C₈-C₁₅₀ alkyl or substituted or unsubstituted aryl, R² is independently hydrogen or unsubstituted C₁-C₆ alkyl, R³ is independently hydrogen or unsubstituted C₁-C₆ alkyl, n is an integer from 2 to 210, z is an integer from 1 to 6 and M⁺ is a monovalent, divalent or trivalent cation. In embodiments, R¹ is unsubstituted linear or branched C₈-C₃₆ alkyl. In embodiments, R¹ is (C₆H₅—CH₂CH₂)₃C₆H₂— (TSP), (C₆H₅—CH₂CH₂)₂C₆H₃— (DSP), (C₆H₅—CH₂CH₂)₁C₆H₄— (MSP), or substituted or unsubstituted naphthyl. In embodiments, the alkoxy carboxylate is C₂₈-25PO-25EO-carboxylate (i.e. unsubstituted C₂₈ alkyl attached to 25 —CH₂—CH(methyl)-O-linkers, attached in turn to 25 —CH₂—CH₂—O— linkers, attached in turn to −COO⁻ or acid or salt thereof including metal cations such as sodium).

In embodiments, the surfactant is an alkoxy sulfate surfactant. An alkoxy sulfate surfactant as provided herein is a surfactant having an alkyl or aryl attached to one or more alkoxylene groups (typically —CH₂—CH(ethyl)-O—, —CH₂—CH(methyl)-O—, or —CH₂—CH₂—O—) which, in turn is attached to —SO₃⁻ or acid or salt thereof including metal cations such as sodium. In some embodiment, the alkoxy sulfate surfactant has the formula R^{A}—(BO)ₑ—(PO)_{f}-(EO)_{g}—SO₃⁻ or acid or salt (including metal cations such as sodium) thereof, wherein R^{A} is C₈-C₃₀ alkyl, BO is —CH₂—CH(ethyl)-O—, PO is —CH₂—CH(methyl)-O—, and EO is —CH₂—CH₂—O—. The symbols e, f and g are integers from 0 to 25 wherein at least one is not zero. In some embodiment, the alkoxy sulfate surfactant is C₁₅-13PO-sulfate (i.e. an unsubstituted C₁₅ alkyl attached to 13 —CH₂—CH(methyl)-O— linkers, in turn attached to —SO₃⁻ or acid or salt thereof including metal cations such as sodium). In some embodiment, the alkoxy sulfate surfactant is C₁₃-13PO-sulfate (i.e. an unsubstituted C₁₃ alkyl attached to 13 —CH₂—CH(methyl)-O— linkers, in turn attached to —SO₃⁻ or acid or salt thereof including metal cations such as sodium).

In embodiments, the alkoxy sulfate surfactant has the formula

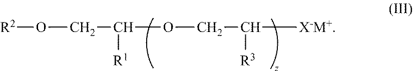

In formula (III) R¹ and R² are independently substituted or unsubstituted C₈-C₁₅₀ alkyl or substituted or unsubstituted aryl. R³ is independently hydrogen or unsubstituted C₁-C₆ alkyl. z is an integer from 2 to 210. X⁻ is

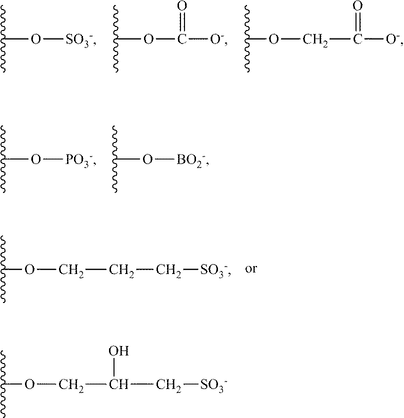

and M⁺ is a monovalent, divalent or trivalent cation. In embodiments, R¹ is branched unsubstituted C₈-C₁₅₀. In embodiments, R¹ is branched or linear unsubstituted C₁₂-C₁₀₀ alkyl, (C₆H₅—CH₂CH₂)₃C₆H₂— (TSP), (C₆H₅—CH₂CH₂)₂C₆H₃— (DSP), (C₆H₅—CH₂CH₂)₁C₆H₄— (MSP), or substituted or unsubstituted naphthyl. In embodiments, the alkoxy sulfate is C₁₆-C₁₆-epoxide-15PO-10EO— sulfate (i.e. a linear unsubstituted C₁₆ alkyl attached to an oxygen, which in turn is attached to a branched unsubstituted C₁₆ alkyl, which in turn is attached to 15 —CH₂—CH(methyl)-O— linkers, in turn attached to 10 —CH₂—CH₂—O— linkers, in turn attached to —SO₃⁻ or acid or salt thereof including metal cations such as sodium.

The alkoxy sulfate surfactant provided herein may be an aryl alkoxy sulfate surfactant. An aryl alkoxy surfactant as provided herein is an alkoxy surfactant having an aryl attached to one or more alkoxylene groups (typically —CH₂—CH(ethyl)-O—, —CH₂—CH(methyl)-O—, or —CH₂—CH₂—O—) which, in turn is attached to —SO₃⁻ or acid or salt thereof including metal cations such as sodium. In embodiments, the aryl alkoxy sulfate surfactant is (C₆H₅—CH₂CH₂)₃C₆H₂-7PO-10EO-sulfate (i.e. tri-styrylphenol attached to 7 —CH₂—CH(methyl)-O— linkers, in turn attached to 10 —CH₂—CH₂—O— linkers, in turn attached to —SO₃⁻ or acid or salt thereof including metal cations such as sodium).

In embodiments, the surfactant is an unsubstituted alkyl sulfate or an unsubstituted alkyl sulfonate surfactant. An alkyl sulfate surfactant as provided herein is a surfactant having an alkyl group attached to —O—SO₃⁻ or acid or salt thereof including metal cations such as sodium. An alkyl sulfonate surfactant as provided herein is a surfactant having an alkyl group attached to —SO₃⁻ or acid or salt thereof including metal cations such as sodium. In embodiments, the surfactant is an unsubstituted aryl sulfate surfactant or an unsubstituted aryl sulfonate surfactant. An aryl sulfate surfactant as provided herein is a surfactant having an aryl group attached to —O—SO₃⁻ or acid or salt thereof including metal cations such as sodium. An aryl sulfonate surfactant as provided herein is a surfactant having an aryl group attached to —SO₃⁻ or acid or salt thereof including metal cations such as sodium. In embodiments, the surfactant is an alkyl aryl sulfonate. Non-limiting examples of alkyl sulfate surfactants, aryl sulfate surfactants, alkyl sulfonate surfactants, aryl sulfonate surfactants and alkyl aryl sulfonate surfactants useful in the embodiments provided herein are alkyl aryl sulfonates (ARS) (e.g. alkyl benzene sulfonate (ABS)), alkane sulfonates, petroleum sulfonates, and alkyl diphenyl oxide (di)sulfonates. Additional surfactants useful in the embodiments provided herein are alcohol sulfates, alcohol phosphates, alkoxy phosphate, sulfosuccinate esters, alcohol ethoxylates, alkyl phenol ethoxylates, quaternary ammonium salts, betains and sultains.

The surfactant as provided herein may be an olefin sulfonate surfactant. In embodiments, the olefin sulfonate surfactant is an internal olefin sulfonate (IOS) or an alfa olefin sulfonate (AOS). In embodiments, the olefin sulfonate surfactant is a C₁₀-C₃₀ (IOS). In some further embodiments, the olefin sulfonate surfactant is C₁₅-C₁₈ IOS. In embodiments, the olefin sulfonate surfactant is C₁₉-C₂₈ IOS. Where the olefin sulfonate surfactant is C₁₅-C₁₈ IOS, the olefin sulfonate surfactant is a mixture (combination) of C₁₅, C₁₆, C₁₇ and C₁₈ alkene, wherein each alkene is attached to a —SO₃⁻ or acid or salt thereof including metal cations such as sodium. Likewise, where the olefin sulfonate surfactant is C₁₉-C₂₈ IOS, the olefin sulfonate surfactant is a mixture (combination) of C₁₉, C₂₀, C₂₁, C₂₂, C₂₃, C₂₄, C₂₅, C₂₆, C₂₇ and C₂₈ alkene, wherein each alkene is attached to a —SO₃⁻ or acid or salt thereof including metal cations such as sodium. In embodiments, the olefin sulfonate surfactant is C₁₉-C₂₃ IOS. As mentioned above, the aqueous composition provided herein may include a plurality of surfactants (i.e. a surfactant blend). In embodiments, the surfactant blend includes a first olefin sulfonate surfactant and a second olefin sulfonate surfactant. In some further embodiments, the first olefin sulfonate surfactant is C₁₅-C₁₈ IOS and the second olefin sulfonate surfactant is C₁₉-C₂₈ IOS.

In embodiments, the aqueous composition includes a plurality of surfactants. In embodiments, the aqueous composition includes a first surfactant and a second surfactant. In embodiments, the first surfactant is an alkoxy sulfate surfactant and the second surfactant is an olefin sulfonate surfactant. In further embodiments, the alkoxy sulfate surfactant is C₁₃-13PO-sulfate (i.e. an unsubstituted C₁₃ alkyl attached to 13 —CH₂—CH(methyl)-O— linkers, in turn attached to —SO₃⁻ or acid or salt thereof including metal cations such as sodium) and the olefin sulfonate surfactant is C₁₉-C₂₃ IOS.

In embodiments, the surfactant has the formula

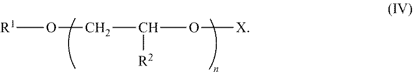

In formula (IV) R¹ is R⁴-substituted or unsubstituted C₈-C₂₀ alkyl, R³-substituted or unsubstituted aryl or R³-substituted or unsubstituted cycloalkyl. R² is independently hydrogen or methyl. R³ is independently R⁴-substituted or unsubstituted C₁-C₁₅ alkyl, R⁴-substituted or unsubstituted aryl or R⁴-substituted or unsubstituted cycloalkyl. R⁴ is independently unsubstituted aryl or unsubstituted cycloalkyl. n is an integer from 25 to 115. X is —SO₃⁻M⁺, —CH₂C(O)O⁻M⁺, —SO₃H or —CH₂C(O)OH, and M⁺ is a monovalent, divalent or trivalent cation.

In embodiments, the symbol n is an integer from 25 to 115. In embodiments, the symbol n is an integer from 30 to 115. In embodiments, the symbol n is an integer from 35 to 115. In embodiments, the symbol n is an integer from 40 to 115. In embodiments, the symbol n is an integer from 45 to 115. In embodiments, the symbol n is an integer from 50 to 115. In embodiments, the symbol n is an integer from 55 to 115. In embodiments, the symbol n is an integer from 60 to 115. In embodiments, the symbol n is an integer from 65 to 115. In embodiments, the symbol n is an integer from 70 to 115. In embodiments, the symbol n is an integer from 75 to 115. In embodiments, the symbol n is an integer from 80 to 115. In embodiments, the symbol n is an integer from 30 to 80. In embodiments, the symbol n is an integer from 35 to 80. In embodiments, the symbol n is an integer from 40 to 80. In embodiments, the symbol n is an integer from 45 to 80. In embodiments, the symbol n is an integer from 50 to 80. In embodiments, the symbol n is an integer from 55 to 80. In embodiments, the symbol n is an integer from 60 to 80. In embodiments, the symbol n is an integer from 65 to 80. In embodiments, the symbol n is an integer from 70 to 80. In embodiments, the symbol n is an integer from 75 to 80. In embodiments, the symbol n is an integer from 30 to 60. In embodiments, the symbol n is an integer from 35 to 60. In embodiments, the symbol n is an integer from 40 to 60. In embodiments, the symbol n is an integer from 45 to 60. In embodiments, the symbol n is an integer from 50 to 60. In embodiments, the symbol n is an integer from 55 to 60. In embodiments, n is 25. In embodiments, n is 50. In embodiments, n is 55. In embodiments, n is 75. In some related embodiments, R¹ is R⁴-substituted or unsubstituted C₈-C₂₀ alkyl. In some other related embodiments, R¹ is R⁴-substituted or unsubstituted C₁₂-C₂₀ alkyl. In some other related embodiments, R¹ is R⁴-substituted or unsubstituted C₁₃-C₂₀ alkyl. In some other related embodiments, R¹ is R⁴-substituted or unsubstituted C₁₃ alkyl. In some other related embodiments, R¹ is unsubstituted C₁₃ alkyl. In other related embodiments, R¹ is a unsubstituted tridecyl (i.e. a C₁₃H₂₇— alkyl radical derived from tridecylalcohol). In yet some other related embodiments, R¹ is R⁴-substituted or unsubstituted C₁₅-C₂₀ alkyl. In some other related embodiments, R¹ is R⁴-substituted or unsubstituted C₁₈ alkyl. In some other related embodiments, R¹ is unsubstituted C₁₈ alkyl. In other related embodiments, R¹ is an unsubstituted oleyl (i.e. a C₁₇H₃₃CH₂— radical derived from oleyl alcohol).

R¹ may be R⁴-substituted or unsubstituted alkyl. In embodiments, R¹ is R⁴-substituted or unsubstituted C₈-C₂₀ alkyl. In embodiments, R¹ is R⁴-substituted or unsubstituted C₁₀-C₂₀ alkyl. In embodiments, R¹ is R⁴-substituted or unsubstituted C₁₂-C₂₀ alkyl. In embodiments, R¹ is R⁴-substituted or unsubstituted C₁₃-C₂₀ alkyl. In embodiments, R¹ is R⁴-substituted or unsubstituted C₁₄-C₂₀ alkyl. In embodiments, R¹ is R⁴-substituted or unsubstituted C₁₆-C₂₀ alkyl. In embodiments, R¹ is R⁴-substituted or unsubstituted C₈-C₁₅ alkyl. In embodiments, R¹ is R⁴-substituted or unsubstituted C₁₀-C₁₅ alkyl. In embodiments, R¹ is R⁴-substituted or unsubstituted C₁₂-C₁₅ alkyl. In embodiments, R¹ is R⁴-substituted or unsubstituted C₁₃-C₁₅ alkyl. In related embodiments, the alkyl is a saturated alkyl. In other related embodiments, R¹ is R⁴-substituted or unsubstituted C₁₃ alkyl. In other related embodiments, R¹ is unsubstituted C₁₃ alkyl. In other related embodiments, R¹ is a tridecyl (i.e. a C₁₃H₂₇— alkyl radical derived from tridecylalcohol). In other related embodiments, R¹ is R⁴-substituted or unsubstituted C₁₈ alkyl. In other related embodiments, R¹ is unsubstituted C₁₈ alkyl. In other related embodiments, R¹ is an oleyl (i.e. a C₁₇H₃₃CH₂— radical derived from oleyl alcohol). In other related embodiments, n is as defined in an embodiment above (e.g. n is at least 40, or at least 50, e.g. 55 to 85).

R¹ may be linear or branched unsubstituted C₈-C₂₀ alkyl. In embodiments, R¹ is branched unsubstituted C₈-C₂₀ alkyl. In embodiments, R¹ is linear unsubstituted C₈-C₂₀ alkyl. In embodiments, R¹ is branched unsubstituted C₈-C₁₈ alkyl. In embodiments, R¹ is branched unsubstituted C₈-C₁₈ alkyl. In embodiments, R¹ is linear unsubstituted C₈-C₁₈ alkyl. In some other related embodiments, R¹ is branched unsubstituted C₁₈ alkyl. In other related embodiments, R¹ is an oleyl (i.e. a C₁₇H₃₃CH₂— radical derived from oleyl alcohol). In embodiments, R¹ is linear or branched unsubstituted C₈-C₁₆ alkyl. In embodiments, R¹ is branched unsubstituted C₈-C₁₆ alkyl. In embodiments, R¹ is linear unsubstituted C₈-C₁₆ alkyl. In embodiments, R¹ is linear or branched unsubstituted C₈-C₁₄ alkyl. In embodiments, R¹ is branched unsubstituted C₈-C₁₄ alkyl. In embodiments, R¹ is linear unsubstituted C₈-C₁₄ alkyl. In other related embodiments, R¹ is branched unsubstituted C₁₃ alkyl. In other related embodiments, R¹ is a tridecyl (i.e. a C₁₃H₂₇— alkyl radical derived from tridecylalcohol). In embodiments, R¹ is linear or branched unsubstituted C₈-C₁₂ alkyl. In embodiments, R¹ is branched unsubstituted C₈-C₁₂ alkyl. In embodiments, R¹ is linear unsubstituted C₈-C₁₂ alkyl. In other related embodiments, n is as defined in an embodiment above (e.g. n is at least 40, or at least 50, e.g. 55 to 85).

In embodiments, where R¹ is a linear or branched unsubstituted alkyl (e.g. branched unsubstituted C₁₀-C₂₀ alkyl), the alkyl is a saturated alkyl (e.g. a linear or branched unsubstituted saturated alkyl or branched unsubstituted C₁₀-C₂₀ saturated alkyl). A “saturated alkyl,” as used herein, refers to an alkyl consisting only of hydrogen and carbon atoms that are bonded exclusively by single bonds. Thus, in embodiments, R¹ may be linear or branched unsubstituted saturated alkyl. In embodiments, R¹ is branched unsubstituted C₁₀-C₂₀ saturated alkyl. In embodiments, R¹ is linear unsubstituted C₁₀-C₂₀ saturated alkyl. In embodiments, R¹ is branched unsubstituted C₁₂-C₂₀ saturated alkyl. In embodiments, R¹ is linear unsubstituted C₁₂-C₂₀ saturated alkyl. In embodiments, R¹ is branched unsubstituted C₁₂-C₁₆ saturated alkyl. In embodiments, R¹ is linear unsubstituted C₁₂-C₁₆ saturated alkyl. In some further embodiment, R¹ is linear unsubstituted C₁₃ saturated alkyl.

In embodiments, where R¹ is a linear or branched unsubstituted alkyl (e.g. branched unsubstituted C₁₀-C₂₀ alkyl), the alkyl is an unsaturated alkyl (e.g. a linear or branched unsubstituted unsaturated alkyl or branched unsubstituted C₁₀-C₂₀ unsaturated alkyl). An “unsaturated alkyl,” as used herein, refers to an alkyl having one or more double bonds or triple bonds. An unsaturated alkyl as provided herein can be mono- or polyunsaturated and can include di- and multivalent radicals. Thus, in embodiments, R¹ may be linear or branched unsubstituted unsaturated alkyl. In embodiments, R¹ is branched unsubstituted C₁₀-C₂₀ unsaturated alkyl. In embodiments, R¹ is linear unsubstituted C₁₀-C₂₀ unsaturated alkyl. In embodiments, R¹ is branched unsubstituted C₁₂-C₂₀ unsaturated alkyl. In embodiments, R¹ is linear unsubstituted C₁₂-C₂₀ unsaturated alkyl. In embodiments, R¹ is branched unsubstituted C₁₂-C₁₈ unsaturated alkyl. In embodiments, R¹ is linear unsubstituted C₁₂-C₁₈ unsaturated alkyl. In embodiments, R¹ is linear unsubstituted C₁₈ unsaturated alkyl. In embodiments, R¹ is branched unsubstituted C₁₈ unsaturated alkyl. In one embodiment, R¹ is linear unsubstituted C₁₈ mono-unsaturated alkyl. In another embodiment, R¹ is linear unsubstituted C₁₈ poly-unsaturated alkyl. In one embodiment, R¹ is branched unsubstituted C₁₈ mono-unsaturated alkyl. In another embodiment, R¹ is branched unsubstituted C₁₈ poly-unsaturated alkyl.

In embodiments, R² is independently hydrogen or methyl.

As provided herein R¹ may be R⁴-substituted or unsubstituted C₈-C₂₀ (e.g., C₁₂-C₁₈) alkyl, R³-substituted or unsubstituted C₅-C₁₀ (e.g., C₅-C₆) aryl or R³-substituted or unsubstituted C₃-C₈ (e.g., C₅-C₇) cycloalkyl. R³ may be independently R⁴-substituted or unsubstituted C₁-C₁₅ (e.g., C₈-C₁₂) alkyl, R⁴-substituted or unsubstituted C₅-C₁₀ (e.g., C₅-C₆) aryl or R⁴-substituted or unsubstituted C₃-C₈ (e.g., C₅-C₇) cycloalkyl. Thus, in embodiments, R³ is R⁴-substituted or unsubstituted C₁-C₁₅ alkyl, R⁴-substituted or unsubstituted C₅-C₁₀ aryl or R⁴-substituted or unsubstituted C₃-C₈ cycloalkyl. R⁴ may be independently unsubstituted C₅-C₁₀ (e.g., C₅-C₆) aryl or unsubstituted C₃-C₈ (e.g., C₅-C₇) cycloalkyl. Thus, in embodiments, R⁴ is independently unsubstituted C₅-C₁₀ aryl or unsubstituted C₃-C₈ cycloalkyl.

M⁺ may be a monovalent, divalent or trivalent cation. In embodiments, M⁺ is a monovalent, divalent or trivalent metal cation. In embodiments, M⁺ is a monovalent or divalent cation (e.g. metal cation). In embodiments, M⁺ is a monovalent cation (e.g. metal cation). In embodiments, M⁺ is a divalent cation (e.g. metal cation). In embodiments, M⁺ is Na⁺, K⁺, NH₄⁺, Ca⁺², Mg⁺² or Ba⁺². A person having ordinary skill in the art will immediately recognize that M⁺ may be a divalent cation where X is a monovalent anion (e.g. where M⁺ is coordinated with more than one compound provided herein or with an additional anion in the surrounding liquid environment).

In embodiments, where multiple R² substituents are present and at least two R² substituents are different, R² substituents with the fewest number of carbons are present to the side of the compound of formula (IV) bound to the X substituent. In this embodiment, the compound of formula (IV) will be increasingly hydrophilic in progressing from the R² substituent to the side of the compound of formula (IV) bound to the X substituent. The term “side of the compound of formula (IV) bound to the X substituent” refers to the side of the compound indicated by asterisks in the below structure:

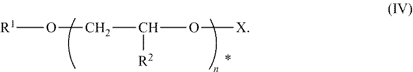

In embodiments of the compound of formula (IV), or embodiments thereof provided herein, where R¹ is unsubstituted C₁₀-C₁₅ alkyl and R² is independently hydrogen or methyl, the symbol n is an integer from 25 to 115. In embodiments, where R¹ is unsubstituted C₁₀-C₁₅ alkyl and R² is independently hydrogen or methyl, the symbol n is an integer from 20 to 75. In embodiments, where R¹ is unsubstituted C₁₀-C₁₅ alkyl and R² is independently hydrogen or methyl, the symbol n is an integer from 20 to 65. In embodiments, where R¹ is unsubstituted C₁₀-C₁₅ alkyl and R² is independently hydrogen or methyl, the symbol n is an integer from 20 to 55. In embodiments, where R¹ is unsubstituted C₁₀-C₁₅ alkyl and R² is independently hydrogen or methyl, the symbol n is an integer from 35 to 75. In embodiments, where R¹ is unsubstituted C₁₀-C₁₅ alkyl and R² is independently hydrogen or methyl, the symbol n is an integer from 35 to 65. In embodiments, where R¹ is unsubstituted C₁₀-C₁₅ alkyl and R² is independently hydrogen or methyl, the symbol n is an integer from 35 to 55. In embodiments, where R¹ is unsubstituted C₁₀-C₁₅ alkyl and R² is independently hydrogen or methyl, the symbol n is an integer from 40 to 75. In embodiments, where R¹ is unsubstituted C₁₀-C₁₅ alkyl and R² is independently hydrogen or methyl, the symbol n is an integer from 40 to 65. In embodiments, where R¹ is unsubstituted C₁₀-C₁₅ alkyl and R² is independently hydrogen or methyl, the symbol n is an integer from 40 to 55. In some further embodiments, where R¹ is unsubstituted C₁₀-C₁₅ alkyl and R² is independently hydrogen or methyl, the symbol n is 55.

In embodiments of the compound of formula (IV), or embodiments thereof provided herein, where R¹ is unsubstituted C₁₂-C₂₀ unsaturated alkyl and R² is independently hydrogen or methyl, the symbol n is an integer from 25 to 115. In embodiments, where R¹ is unsubstituted C₁₂-C₂₀ unsaturated alkyl and R² is independently hydrogen or methyl, the symbol n is an integer from 40 to 115. In embodiments, where R¹ is unsubstituted C₁₂-C₂₀ unsaturated alkyl and R² is independently hydrogen or methyl, the symbol n is an integer from 50 to 115. In embodiments, where R¹ is unsubstituted C₁₂-C₂₀ unsaturated alkyl and R² is independently hydrogen or methyl, the symbol n is an integer from 60 to 115. In embodiments, where R¹ is unsubstituted C₁₂-C₂₀ unsaturated alkyl and R² is independently hydrogen or methyl, the symbol n is an integer from 70 to 115. In embodiments, where R¹ is unsubstituted C₁₂-C₂₀ unsaturated alkyl and R² is independently hydrogen or methyl, the symbol n is an integer from 75 to 115. In some further embodiments, where R¹ is unsubstituted C₁₂-C₂₀ unsaturated alkyl and R² is independently hydrogen or methyl, the symbol n is 75. In embodiments, where R¹ is unsubstituted C₁₂-C₂₀ unsaturated alkyl and R² is independently hydrogen or methyl, the symbol n is an integer from 80 to 115. In embodiments, where R¹ is unsubstituted C₁₂-C₂₀ unsaturated alkyl and R² is independently hydrogen or methyl, the symbol n is an integer from 85 to 115. In embodiments, where R¹ is unsubstituted C₁₂-C₂₀ unsaturated alkyl and R² is independently hydrogen or methyl, the symbol n is an integer from 90 to 115.

In embodiments, the surfactant has the formula

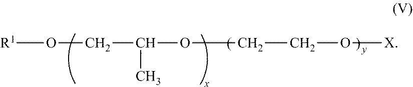

In formula (V) R¹ and X are defined as above (e.g. in formula (IV)). y is an integer from 5 to 40, and x is an integer from 35 to 50. In some further embodiments, y is 10 and x is 45. In some other further embodiments, R¹ is C₁₃ alkyl. In some further embodiments, y is 30 and x is 45. In some other further embodiments, R¹ is unsubstituted unsaturated C₁₈ alkyl. In embodiments, R¹ is linear unsubstituted C₁₈ unsaturated alkyl. In embodiments, R¹ is branched unsubstituted C₁₈ unsaturated alkyl. In one embodiment, R¹ is linear unsubstituted C₁₈ mono-unsaturated alkyl. In another embodiment, R¹ is linear unsubstituted C₁₈ poly-unsaturated alkyl. In one embodiment, R¹ is branched unsubstituted C₁₈ mono-unsaturated alkyl. In another embodiment, R¹ is branched unsubstituted C₁₈ poly-unsaturated alkyl.

In some embodiment of the compound of formula (IV) or (V), or embodiments thereof disclosed herein, where R¹ is unsubstituted C₁₃ alkyl, n is 55, X is —SO₃⁻M⁺, and M⁺ is a divalent cation (e.g. Na²⁺). In a further embodiment, x is 45 and y is 10. In another embodiment of the compound of formula (IV) or (V), or embodiments thereof disclosed herein, where R¹ is unsubstituted C₁₈ unsaturated alkyl, n is 75, X is —CH₂C(O)O⁻M⁺, and M⁺ is a monovalent cation (e.g. Na⁺). In a further embodiment, x is 45 and y is 30.

Useful surfactants are disclosed, for example, in U.S. Pat. Nos. 3,811,504, 3,811,505, 3,811,507, 3,890,239, 4,463,806, 6,022,843, 6,225,267, 7,629,299; WIPO Patent Application WO/2008/079855, WO/2012/027757 and WO/2011/094442; as well as U.S. Patent Application Nos. 2005/0199395, 2006/0185845, 2006/018486, 2009/0270281, 2011/0046024, 2011/0100402, 2011/0190175, 2007/0191633, 2010/004843, 2011/0201531, 2011/0190174, 2011/0071057, 2011/0059873, 2011/0059872, 2011/0048721, 2010/0319920, and 2010/0292110. Additional useful surfactants are surfactants known to be used in enhanced oil recovery methods, including those discussed in D. B. Levitt, A. C. Jackson, L. Britton and G. A. Pope, “Identification and Evaluation of High-Performance EOR Surfactants,” SPE 100089, conference contribution for the SPE Symposium on Improved Oil Recovery Annual Meeting, Tulsa, Okla., Apr. 24-26, 2006.

A person having ordinary skill in the art will immediately recognize that many surfactants are commercially available as blends of related molecules (e.g. IOS and ABS surfactants). Thus, where a surfactant is present within a composition provided herein, a person of ordinary skill would understand that the surfactant might be a blend of a plurality of related surfactant molecules (as described herein and as generally known in the art). In embodiments, the surfactant is a surfactant blend. In embodiments, the surfactant is a single surfactant. Where the surfactant is a single surfactant, the aqueous composition includes one surfactant type.

In embodiments, the total surfactant concentration (i.e. the total amount of all surfactant types within the aqueous compositions and emulsion compositions provided herein) is from about 0.05% w/w to about 10% w/w. In embodiments, the total surfactant concentration in the aqueous composition is from about 0.25% w/w to about 10% w/w. In embodiments, the total surfactant concentration in the aqueous composition is about 0.5% w/w. In embodiments, the total surfactant concentration in the aqueous composition is about 1.0% w/w. In embodiments, the total surfactant concentration in the aqueous composition is about 1.25% w/w. In embodiments, the total surfactant concentration in the aqueous composition is about 1.5% w/w. In embodiments, the total surfactant concentration in the aqueous composition is about 1.75% w/w. In embodiments, the total surfactant concentration in the aqueous composition is about 2.0% w/w. In embodiments, the total surfactant concentration in the aqueous composition is about 2.5% w/w. In embodiments, the total surfactant concentration in the aqueous composition is about 3.0% w/w. In embodiments, the total surfactant concentration in the aqueous composition is about 3.5% w/w. In embodiments, the total surfactant concentration in the aqueous composition is about 4.0% w/w. In embodiments, the total surfactant concentration in the aqueous composition is about 4.5% w/w. In embodiments, the total surfactant concentration in the aqueous composition is about 5.0% w/w. In embodiments, the total surfactant concentration in the aqueous composition is about 5.5% w/w. In embodiments, the total surfactant concentration in the aqueous composition is about 6.0% w/w. In embodiments, the total surfactant concentration in the aqueous composition is about 6.5% w/w. In embodiments, the total surfactant concentration in the aqueous composition is about 7.0% w/w. In embodiments, the total surfactant concentration in the aqueous composition is about 7.5% w/w. In embodiments, the total surfactant concentration in the aqueous composition is about 8.0% w/w. In embodiments, the total surfactant concentration in the aqueous composition is about 9.0% w/w. In embodiments, the total surfactant concentration in the aqueous composition is about 10% w/w. In embodiments, the total surfactant concentration in the aqueous composition is about 0.05% w/w, 0.25% w/w, 0.5% w/w, 1.25% w/w, 1.5% w/w, 1.75% w/w, 2.0% w/w, 2.5% w/w, 3.0% w/w, 3.5% w/w, 4.5% w/w, 4.5% w/w, 5.0% w/w, 5.5% w/w, 6.0% w/w, 6.5% w/w, 7.0% w/w, 7.5% w/w, 8.0% w/w, 8.5% w/w or 10% w/w. In embodiments, the total surfactant concentration in the aqueous composition is about 1% w/w. In another embodiment, the total surfactant concentration in the aqueous composition is about 0.6% w/w. In another embodiment, the total surfactant concentration in the aqueous composition is about 0.4% w/w. In embodiments, the surfactant is present at a concentration of at least 0.1% w/w. A person of ordinary skill in the art will immediately recognize that the above referenced values refer to weight percent of compound per weight of aqueous composition.

In embodiments, the boron oxygenate is present in an amount sufficient to increase the solubility of the surfactant in the aqueous composition relative to the absence of the boron oxygenate. In other words, in the presence of a sufficient amount of the boron oxygenate, the solubility of the surfactant in the aqueous composition is higher than in the absence of the boron oxygenate. In embodiments, the boron oxygenate is present in an amount sufficient to increase the solubility of the surfactant in the aqueous composition relative to the absence of the boron oxygenate. Thus, in the presence of a sufficient amount of the boron oxygenate the solubility of the surfactant in the aqueous composition is higher than in the absence of the boron oxygenate.

In embodiments, the boron oxygenate is present in an amount sufficient to decrease the adsorption of the surfactant to the solid material in a petroleum reservoir relative to the absence of the boron oxygenate. In other words, in the presence of a sufficient amount of the boron oxygenate, the adsorption of the surfactant to the solid material in a petroleum reservoir is lower than in the absence of the boron oxygenate. In embodiments, the boron oxygenate is present in an amount sufficient to decrease the adsorption of the surfactant to the solid material in a petroleum reservoir relative to the absence of the boron oxygenate. Thus, in the presence of a sufficient amount of the boron oxygenate the adsorption of the surfactant to the solid material in a petroleum reservoir is lower than in the absence of the boron oxygenate.

In embodiments, the boron oxygenate is present in a pH stabilizing amount. A “pH stabilizing amount” means that the boron oxygenate is present in an amount in which the pH changes at a slower rate in the presence of boron oxygenate than in the absence of the boron oxygenate. The rate of change may be 0%, 5%, 10%, 20%, 30%, 40%, 50%, 60%, 70%, 80%, 90% or 100% slower. In some embodiments, the rate of change is 2, 3, 4, 5, 6, 7, 8, 9 or 10 times slower. In embodiments, the boron oxygenate is present in an amount in which the pH remains constant (i.e., remains the same over time).

In embodiments, the boron oxygenate (e.g. sodium borate) is present from about 0.05% w/w to about 10% w/w. In embodiments, the boron oxygenate (e.g. sodium borate) is present from about 0.1% w/w to about 10% w/w. In embodiments, the boron oxygenate (e.g. sodium borate) is present from about 0.5% w/w to about 10% w/w. In embodiments, the boron oxygenate (e.g. sodium borate) is present from about 1% w/w to about 10% w/w. In embodiments, the boron oxygenate (e.g. sodium borate) is present from about 1.5% w/w to about 10% w/w. In embodiments, the boron oxygenate (e.g. sodium borate) is present from about 2% w/w to about 10% w/w. In embodiments, the boron oxygenate (e.g. sodium borate) is present from about 2.5% w/w to about 10% w/w. In embodiments, the boron oxygenate (e.g. sodium borate) is present from about 3% w/w to about 10% w/w. In embodiments, the boron oxygenate (e.g. sodium borate) is present from about 3.5% w/w to about 10% w/w. In embodiments, the boron oxygenate (e.g. sodium borate) is present from about 4% w/w to about 10% w/w. In embodiments, the boron oxygenate (e.g. sodium borate) is present from about 4.5% w/w to about 10% w/w. In embodiments, the boron oxygenate (e.g. sodium borate) is present from about 5% w/w to about 10% w/w. In embodiments, the boron oxygenate (e.g. sodium borate) is present from about 5.5% w/w to about 10% w/w. In embodiments, the boron oxygenate (e.g. sodium borate) is present from about 6% w/w to about 10% w/w. In embodiments, the boron oxygenate (e.g. sodium borate) is present from about 6.5% w/w to about 10% w/w. In embodiments, the boron oxygenate (e.g. sodium borate) is present from about 7% w/w to about 10% w/w. In embodiments, the boron oxygenate (e.g. sodium borate) is present from about 7.5% w/w to about 10% w/w. In embodiments, the boron oxygenate (e.g. sodium borate) is present from about 8% w/w to about 10% w/w. In embodiments, the boron oxygenate (e.g. sodium borate) is present from about 8.5% w/w to about 10% w/w. In embodiments, the boron oxygenate (e.g. sodium borate) is present from about 9% w/w to about 10% w/w. In embodiments, the boron oxygenate (e.g. sodium borate) is present from about 9.5% w/w to about 10% w/w. In embodiments, the boron oxygenate (e.g. sodium borate) is present at about 3.75% w/w. In embodiments, the boron oxygenate (e.g. sodium borate) is present at about 1% w/w.

In embodiments, the aqueous composition further includes a viscosity enhancing water-soluble polymer. In embodiments, the viscosity enhancing water-soluble polymer is a hydrolyzed polymer (e.g. hydrolyzed or partially hydrolyzed polyacrylamide, HPAM). In embodiments, the viscosity enhancing water-soluble polymer may be a biopolymer (e.g. polyhydroxy polymer or polysaccharide) such as xanthan gum or scleroglucan, a synthetic polymer such as polyacrylamide, hydrolyzed polyacrylamide or co-polymers of acrylamide and acrylic acid, 2-acrylamido 2-methyl propane sulfonate or N-vinyl pyrrolidone, a synthetic polymer such as polyethylene oxide, or any other high molecular weight polymer soluble in water or brine. In embodiments, the viscosity enhancing water-soluble polymer is polyacrylamide or a co-polymer of polyacrylamide. In one embodiment, the viscosity enhancing water-soluble polymer is a partially (e.g. 20%, 25%, 30%, 35%, 40%, 45%) hydrolyzed anionic polyacrylamide. In some further embodiment, the viscosity enhancing water-soluble polymer has a molecular weight of approximately about 8×10⁶. In some other further embodiment, the viscosity enhancing water-soluble polymer has a molecular weight of approximately about 18×10⁶. Non-limiting examples of commercially available polymers useful for the invention including embodiments provided herein are Flopaam 3330S and Flopaam 3630S.

In embodiments, the polymer is present from about 100 ppm to about 5000 ppm. In embodiments, the polymer is present from about 200 ppm to about 5,000 ppm. In embodiments, the polymer is present from about 400 ppm to about 5,000 ppm. In embodiments, the polymer is present from about 600 ppm to about 5,000 ppm. In embodiments, the polymer is present from about 800 ppm to about 5,000 ppm. In embodiments, the polymer is present from about 1,000 ppm to about 5,000 ppm. In embodiments, the polymer is present from about 1,500 ppm to about 5,000 ppm. In embodiments, the polymer is present from about 2,000 ppm to about 5,000 ppm. In embodiments, the polymer is present from about 2,500 ppm to about 5,000 ppm. In embodiments, the polymer is present from about 3,000 ppm to about 5,000 ppm. In embodiments, the polymer is present from about 3,500 ppm to about 5,000 ppm. In embodiments, the polymer is present from about 4,000 ppm to about 5,000 ppm. In embodiments, the polymer is present from about 4,500 ppm to about 5,000 ppm. In embodiments, the polymer is present at about 800 ppm. In embodiments, the polymer is present at about 2,000 ppm. In embodiments, the polymer is present at about 2,500 ppm.

In embodiments, the boron oxygenate is present in an amount sufficient to increase the solubility of the viscosity enhancing water-soluble polymer in the aqueous composition relative to the absence of the boron oxygenate. In other words, in the presence of a sufficient amount of the boron oxygenate, the solubility of the viscosity enhancing water-soluble polymer in the aqueous composition is higher than in the absence of the boron oxygenate. Thus, in the presence of a sufficient amount of the boron oxygenate the solubility of the viscosity enhancing water-soluble polymer in the aqueous composition is higher than in the absence of the boron oxygenate.

The aqueous compositions provided herein may further include a gas. For instance, the gas may be combined with the aqueous composition to reduce its mobility by decreasing the liquid flow in the pores of the solid material (e.g. rock). In embodiments, the gas may be supercritical carbon dioxide, nitrogen, natural gas or mixtures of these and other gases. In embodiments, the gas may increase the viscosity of the aqueous composition or emulsions provided herein. In embodiments, the gas may be supercritical carbon dioxide, nitrogen, natural gas or mixtures of these and other gases.

In embodiments, the aqueous composition further includes a co-solvent. In embodiments, the co-solvent is an alcohol, alcohol ethoxylate, glycol ether, glycols, or glycerol. In embodiments, the aqueous composition includes water, boron oxygenate, a multivalent mineral cation (e.g. from gypsum), a co-solvent and optionally a surfactant. The aqueous compositions provided herein may include more than one co-solvent. Thus, in embodiments, the aqueous composition includes a plurality of different co-solvents. Where the aqueous composition includes a plurality of different co-solvents, the different co-solvents can be distinguished by their chemical (structural) properties. For example, the aqueous composition may include a first co-solvent, a second co-solvent and a third co-solvent, wherein the first co-solvent is chemically different from the second and the third co-solvent, and the second co-solvent is chemically different from the third co-solvent. In embodiments, the plurality of different co-solvents includes at least two different alcohols (e.g. a C₁-C₆ alcohol and a C₁-C₄ alcohol). In embodiments, the aqueous composition includes a C₁-C₆ alcohol and a C₁-C₄ alcohol. In embodiments, the plurality of different co-solvents includes at least two different alkoxy alcohols (e.g. a C₁-C₆ alkoxy alcohol and a C₁-C₄ alkoxy alcohol). In embodiments, the aqueous composition includes a C₁-C₆ alkoxy alcohol and a C₁-C₄ alkoxy alcohol. In embodiments, the plurality of different co-solvents includes at least two co-solvents selected from the group consisting of alcohols, alkyl alkoxy alcohols and phenyl alkoxy alcohols. For example, the plurality of different co-solvents may include an alcohol and an alkyl alkoxy alcohol, an alcohol and a phenyl alkoxy alcohol, or an alcohol, an alkyl alkoxy alcohol and a phenyl alkoxy alcohol. The alkyl alkoxy alcohols or phenyl alkoxy alcohols provided herein have a hydrophobic portion (alkyl or aryl chain), a hydrophilic portion (e.g. an alcohol) and optionally an alkoxy (ethoxylate or propoxylate) portion. Thus, in embodiments, the co-solvent is an alcohol, alkoxy alcohol, glycol ether, glycol or glycerol.

In embodiments, the co-solvent has the formula

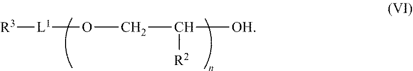

In formula (VI), L¹ is unsubstituted C₁-C₆ alkylene, unsubstituted phenylene, unsubstituted cyclohexylene, unsubstituted cyclopentylene or methyl-substituted cyclopentylene. R² is independently hydrogen, methyl or ethyl. R³ is independently hydrogen or

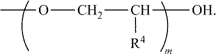

R⁴ is independently hydrogen, methyl or ethyl, n is an integer from 0 to 30, and m is an integer from 0 to 30. In one embodiment, n is an integer from 0 to 25. In one embodiment, n is an integer from 0 to 20. In one embodiment, n is an integer from 0 to 15. In one embodiment, n is an integer from 0 to 10. In one embodiment, n is an integer from 0 to 5. In one embodiment, n is 1. In embodiments, n is 3. In one embodiment, n is 5. In one embodiment, m is an integer from 0 to 25. In one embodiment, m is an integer from 0 to 20. In one embodiment, m is an integer from 0 to 15. In one embodiment, m is an integer from 0 to 10. In one embodiment, m is an integer from 0 to 5. In one embodiment, m is 1. In embodiments, m is 3. In one embodiment, m is 5. In formula (VI) each of R² and R⁴ can appear more than once and can be optionally different. For example, in one embodiment where n is 2, R² appears twice and can be optionally different. In embodiments, where m is 3, R⁴ appears three times and can be optionally different.

L¹ may be linear or branched unsubstituted alkylene. In one embodiment, L¹ of formula (VI) is linear unsubstituted C₁-C₆ alkylene. In one embodiment, L¹ of formula (VI) is branched unsubstituted C₁-C₆ alkylene. In embodiments, L¹ of formula (VI) is linear unsubstituted C₂-C₆ alkylene. In embodiments, L¹ of formula (VI) is branched unsubstituted C₂-C₆ alkylene. In embodiments, L¹ of formula (VI) is linear unsubstituted C₃-C₆ alkylene. In embodiments, L¹ of formula (VI) is branched unsubstituted C₃-C₆ alkylene. In embodiments, L¹ of formula (VI) is linear unsubstituted C₄-C₆ alkylene. In embodiments, L¹ of formula (VI) is branched unsubstituted C₄-C₆ alkylene. In embodiments, L¹ of formula (VI) is linear unsubstituted C₄-alkylene. In embodiments, L¹ of formula (VI) is branched unsubstituted C₄-alkylene.

In one embodiment, where L¹ is linear or branched unsubstituted alkylene (e.g. branched unsubstituted C₁-C₆ alkylene), the alkylene is a saturated alkylene (e.g. a linear or branched unsubstituted saturated alkylene or branched unsubstituted C₁-C₆ saturated alkylene). A “saturated alkylene,” as used herein, refers to an alkylene consisting only of hydrogen and carbon atoms that are bonded exclusively by single bonds. Thus, in one embodiment, L¹ is linear or branched unsubstituted saturated alkylene. In one embodiment, L¹ of formula (VI) is linear unsubstituted saturated C₁-C₆ alkylene. In one embodiment, L¹ of formula (VI) is branched unsubstituted saturated C₁-C₆ alkylene. In embodiments, L¹ of formula (VI) is linear unsubstituted saturated C₂-C₆ alkylene. In embodiments, L¹ of formula (VI) is branched unsubstituted saturated C₂-C₆ alkylene. In embodiments, L¹ of formula (VI) is linear unsubstituted saturated C₃-C₆ alkylene. In embodiments, L¹ of formula (VI) is branched unsubstituted saturated C₃-C₆ alkylene. In embodiments, L¹ of formula (VI) is linear unsubstituted saturated C₄-C₆ alkylene. In embodiments, L¹ of formula (VI) is branched unsubstituted saturated C₄-C₆ alkylene. In embodiments, L¹ of formula (VI) is linear unsubstituted saturated C₄-alkylene. In embodiments, L¹ of formula (VI) is branched unsubstituted saturated C₄-alkylene.

In one embodiment, L¹ of formula (VI) is substituted or unsubstituted cycloalkylene or unsubstituted arylene. In one embodiment, L¹ of formula (VI) is R⁷-substituted or unsubstituted cyclopropylene, wherein R⁷ is C₁-C₃ alkyl. In embodiments, L¹ of formula (VI) is R⁸-substituted or unsubstituted cyclobutylene, wherein R⁸ is C₁-C₂ alkyl. In embodiments, L¹ of formula (VI) is R⁹-substituted or unsubstituted cyclopentylene, wherein R⁹ is C₁-alkyl. In embodiments, L¹ of formula (VI) is R¹⁰-substituted or unsubstituted cyclopentylene, wherein R¹° is unsubstituted cyclohexyl. In one embodiment, L¹ of formula (VI) is unsubstituted phenylene, unsubstituted cyclohexylene, unsubstituted cyclopentylene or methyl-substituted cyclopentylene.

In one embodiment, R³-L¹- of formula (VI) is C₁-C₆ alkyl, unsubstituted phenyl, unsubstituted cyclohexyl, unsubstituted cyclopentyl or a methyl-substituted cycloalkyl.

In one embodiment, the co-solvent has the structure of formula

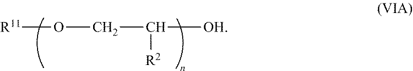

In formula (VIA), R¹¹ is C₁-C₆ alkyl, unsubstituted phenyl, unsubstituted cyclohexyl, unsubstituted cyclopentyl or a methyl-substituted cycloalkyl.

In one embodiment, n and m are independently 1 to 20. In embodiments, n and m are independently 1 to 15. In embodiments, n and m are independently 1 to 10. In one embodiment, n and m are independently 1 to 6. In one embodiment, n and m are independently 1.

The co-solvent included in the aqueous compositions provided herein may be a monohydric or a dihydric alkoxy alcohol (e.g. C₁-C₆ alkoxy alcohol or C₁-C₆ alkoxy diol). Where the co-solvent is a monohydric alcohol, the co-solvent has the formula (VI) and R³ is hydrogen. Where the co-solvent is a diol, the co-solvent has the formula (VI) and R³ is

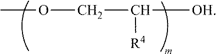

In one embodiment, L¹ is linear unsubstituted C₄ alkylene and n is 3. In one embodiment, the co-solvent is triethyleneglycol butyl ether. In embodiments, the co-solvent is tetraethylene glycol. In further embodiments, m is 3. In one embodiment, L¹ is linear unsubstituted C₄ alkylene and n is 5. In one embodiment, the co-solvent is pentaethyleneglycol n-butyl ether. In further embodiments, m is 5. In one embodiment, L¹ is branched unsubstituted C₄ alkylene and n is 1. In one embodiment, the co-solvent is ethyleneglycol iso-butyl ether. In further embodiments, m is 1. In one embodiment, L¹ is branched unsubstituted C₄ alkylene and n is 3. In one embodiment, the co-solvent is triethyleneglycol iso-butyl ether. In further embodiments, m is 3. In one embodiment, the co-solvent is ethylene glycol or propylene glycol. In embodiments, the co-solvent is ethylene glycol alkoxylate or propylene glycol alkoxylate. In one embodiment, the co-solvent is propylene glycol diethoxylate or propylene glycoltriethoxylate. In one embodiment, the co-solvent is propylene glycol tetraethoxylate.

In the structure of formula (VI), R³ may be hydrogen or

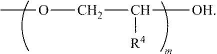

Thus in one embodiment, R³ is

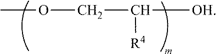

In one embodiment, the co-solvent provided herein may be an alcohol or diol (C₁-C₆ alcohol or C₁-C₆ diol). Where the co-solvent is an alcohol, the co-solvent has a structure of formula (VI), where R³ is hydrogen and n is 0. Where the co-solvent is a diol, the co-solvent has a structure of formula (VI), where R³ is

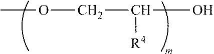

and n and m are 0. Thus, in one embodiment, n and m are independently 0. In one embodiment, L¹ is linear or branched unsubstituted C₁-C₆ alkylene. In embodiments, L¹ is linear or branched unsubstituted C₂-C₆ alkylene. In one embodiment, L¹ is linear or branched unsubstituted C₂-C₆ alkylene. In one embodiment L¹ is linear or branched unsubstituted C₃-C₆ alkylene. In embodiments, L¹ is linear or branched unsubstituted C₄-C₆ alkylene. In one embodiment, L¹¹ is linear or branched unsubstituted C₄-alkylene. In one embodiment, L¹ is branched unsubstituted butylene. In one embodiment, the co-solvent has the structure of formula

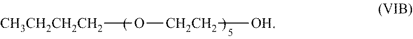

In embodiments, the co-solvent has the structure of formula

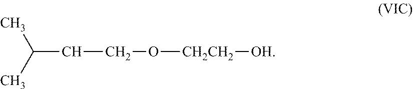

In one embodiment, the co-solvent has the structure of formula

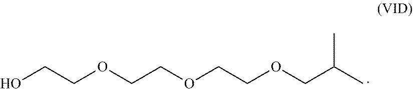

The structure of formula (VID) is also referred to herein as triethylene glycol mono butyl ether (TEGBE). In embodiments, the co-solvent is TEGBE (triethylene glycol mono butyl ether). In embodiments, TEGBE is present at a concentration from about 0.01% to about 2%. In embodiments, TEGBE is present at a concentration from about 0.05% to about 1.5%. In embodiments, TEGBE is present at a concentration from about 0.2% to about 1.25%. In embodiments, TEGBE is present at a concentration from about 0.25% to about 1%. In embodiments, TEGBE is present at a concentration from about 0.5% to about 0.75%. In embodiments, TEGBE is present at a concentration of about 0.25%. In embodiments, TEGBE is present at a concentration of about 1%.

In embodiments, the co-solvent is IBA (isobutyl alcohol). In embodiments, IBA is present at a concentration from about 0.01% to about 2%. In embodiments, IBA is present at a concentration from about 0.05% to about 1.5%. In embodiments, IBA is present at a concentration from about 0.2% to about 1.25%. In embodiments, IBA is present at a concentration from about 0.25% to about 1%. In embodiments, IBA is present at a concentration from about 0.5% to about 0.75%. In embodiments, IBA is present at a concentration of about 0.25%. In embodiments, IBA is present at a concentration of about 1%.

The aqueous composition provided herein including embodiments thereof, may include seawater, or fresh water from an aquifer, river or lake. In embodiments, the aqueous composition includes hard brine water or soft brine water. In embodiments, the water is soft brine water. In soft brine water the boron oxygenate provides for enhanced soap generation from the active oils, lower surfactant adsorption to the solid material (e.g. rock) in the reservoir and increased solubility of viscosity enhancing water soluble polymers.

The aqueous composition provided herein including embodiments thereof may include more than 10 ppm of multivalent mineral cations (e.g. divalent cations such as Ba²⁺, Fe²⁺, Ca²⁺ and Mg²⁺) combined. In embodiments, the aqueous composition includes more than 10 ppm of multivalent mineral cations (e.g. divalent cations such as Ba²⁺, Fe²⁺, Ca²⁺ and Mg²⁺) combined. The aqueous composition may include more than 100 ppm of multivalent mineral cations (e.g. divalent cations such as Ca²⁺ and Mg²⁺) combined. In embodiments, the aqueous composition includes more than 1000 ppm of multivalent mineral cations (e.g. divalent cations such as Ba²⁺, Fe²⁺, Ca²⁺ and Mg²⁺) combined. In embodiments, the aqueous composition includes more than 3000 ppm of multivalent mineral cations (e.g. divalent cations such as Ba²⁺, Fe²⁺, Ca²⁺ and Mg²⁺) combined.

In embodiments, the aqueous composition includes more than 10 ppm of hardness ions such as polyvalent (e.g. divalent) cations. In embodiments, the aqueous composition includes more than 100 ppm of hardness ions such as polyvalent (e.g. divalent) cations. In embodiments, the aqueous composition includes more than 1000 ppm of hardness ions such as polyvalent (e.g. divalent) cations. In embodiments, the divalent cations are Ba²⁺, Fe²⁺, Ca²⁺ and Mg²⁺. The term “hardness ions” as used herein refers to multivalent ions causing water hardness.

In embodiments, the aqueous composition has a pH of at least about 7. In embodiments, the aqueous composition has a pH of at least about 7.5. In embodiments, the aqueous composition has a pH of at least about 8.0. In embodiments, the aqueous composition has a pH of at least about 8.5. In embodiments, the aqueous composition has a pH of at least about 9.0. In embodiments, the aqueous composition has a pH of at least about 9.5. In embodiments, the aqueous composition has a pH of at least about 10.0. In embodiments, the aqueous composition has a pH of at least about 10.5. In embodiments, the aqueous composition has a pH of at least about 11.0. In embodiments, the aqueous composition has a pH of at least about 11.5. In embodiments, the aqueous composition has a pH of about 10. In embodiments, the aqueous composition has a pH of about 11.

In embodiments, the aqueous composition has a salinity of at least 5,000 ppm. In embodiments, the aqueous composition has a salinity of at least 10,000 ppm. In embodiments, the aqueous composition has a salinity of at least 50,000 ppm. In embodiments, the aqueous composition has a salinity of at least 100,000 ppm. In embodiments, the aqueous composition has a salinity of at least 150,000 ppm. The total range of salinity (total dissolved solids in the brine) is 100 ppm to saturated brine (about 260,000 ppm). The aqueous composition may include seawater, brine or fresh water from an aquifer, river or lake. The aqueous combination may further include salt to increase the salinity. In embodiments, the salt is NaCl, KCl, CaCl₂, or MgCl₂.

The aqueous composition provided herein may include water, a plurality of surfactants, boron oxygenate, a multivalent mineral cation, a co-solvent and a polymer. Thus, in embodiments, the aqueous composition includes an alkoxy sulfate surfactant, wherein the alkoxy sulfate surfactant is C₁₃-13PO-sulfate present at about 0.6% w/w; an olefin sulfonate surfactant, wherein the olefin sulfonate surfactant is C₁₉-C₂₃ IOS present at about 0.4% w/w; isobutyl alcohol present at about 1% w/w; boron oxygenate (e.g. sodium metaborate) present at about 3.75% w/w and a polymer, wherein the polymer is 3330S Flopaam present at about 2,500 ppm.

In another aspect, an emulsion composition is provided including an unrefined petroleum, water, a surfactant, a boron oxygenate and a multivalent mineral cation.

In another aspect, an emulsion composition is provided including an unrefined petroleum, water, a co-solvent, a boron oxygenate and a multivalent mineral cation.

In embodiments, the emulsion compositions include the components, and amounts thereof, set forth above in the description of the aqueous compositions above. The emulsion composition provided herein may include a combination of one or more surfactants (i.e. a surfactant blend including for example, a first, a second and a third surfactant). For example, in embodiments the emulsion composition includes an alkoxy sulfonate surfactant and an internal olefin sulfonate surfactant. In embodiments, the boron oxygenate is present in an amount sufficient to increase the solubility of the surfactant in the aqueous phase relative to the absence of the boron oxygenate. In other words, in the presence of a sufficient amount of the boron oxygenate, the solubility of the surfactant in the emulsion composition is higher than in the absence of the boron oxygenate. In embodiments, the boron oxygenate is present in an amount sufficient to increase the solubility of the surfactant in the emulsion composition (e.g. in the aqueous phase) relative to the absence of the boron oxygenate. Thus, in the presence of a sufficient amount of the boron oxygenate the solubility of the surfactant in the emulsion composition is higher than in the absence of the boron oxygenate (e.g. the surfactant does not precipitate out of the emulsion or aqueous phase).

The emulsion provided herein includes the aqueous composition provided herein including embodiments thereof (e.g. an aqueous composition including an alkoxy sulfate surfactant, wherein the alkoxy sulfate surfactant is C₁₃-13PO-sulfate present, an olefin sulfonate surfactant, wherein the olefin sulfonate surfactant is C₁₉-C₂₃ IOS, a co-solvent, wherein the co-solvent is isobutyl alcohol, a boron oxygenate, wherein the boron oxygenate is sodium metaborate, a polymer, wherein the polymer is 3330S Flopaam and a sulfate mineral, wherein the sulfate mineral is gypsum). In embodiments, the emulsion composition is within a petroleum reservoir. In embodiments, the sulfate mineral is gypsum.

In embodiments, the boron oxygenate is present in an amount sufficient to decrease the adsorption of the surfactant to the solid material in a petroleum reservoir relative to the absence of the boron oxygenate. In other words, in the presence of a sufficient amount of the boron oxygenate, the adsorption of the surfactant to the solid material in a petroleum reservoir is lower than in the absence of the boron oxygenate. Thus, in the presence of a sufficient amount of the boron oxygenate the adsorption of the surfactant to the solid material in a petroleum reservoir is lower than in the absence of the boron oxygenate. In embodiments, the boron oxygenate (e.g. sodium metaborate) is present at a concentration of at least 0.1% w/w (e.g. 3.75% w/w).

In embodiments, the surfactant is an anionic surfactant, a non-ionic surfactant, a zwitterionic surfactant or a cationic surfactant. In embodiments, the anionic surfactant is an alkoxy carboxylate surfactant, an alkoxy sulfate surfactant, an alkoxy sulfonate surfactant, an alkyl sulfonate surfactant, an aryl sulfonate surfactant or an olefin sulfonate surfactant. In embodiments, the surfactant is present at a concentration of at least 0.1% w/w (e.g. 0.4% w/w, 0.6% w/w).

In embodiments, the emulsion composition includes a viscosity enhancing water soluble polymer. In embodiments, the viscosity enhancing water soluble polymer is polyacrylamide or a co-polymer of polyacrylamide.

In embodiments, the emulsion composition includes a co-solvent. In embodiments, the co-solvent is an alcohol, alcohol ethoxylate, glycol ether, glycols, or glycerol. In embodiments, the emulsion composition includes unrefined petroleum, water, a surfactant, boron oxygenate, a multivalent mineral cation (e.g. gypsum) and a co-solvent. As described above for the aqueous composition the emulsion compositions provided herein may include more than one co-solvent. Thus, in embodiments, the emulsion composition includes a plurality of different co-solvents. In embodiments, the co-solvent is IBA (isobutyl alcohol). In embodiments, IBA is present at a concentration of about 0.25%. In embodiments, IBA is present at a concentration of about 1%. In embodiments, the emulsion composition includes a gas. In embodiments, the water is soft brine water.

In embodiments, the emulsion composition is a microemulsion. A “microemulsion” as referred to herein is a thermodynamically stable mixture of oil, water and surfactants that may also include additional components such as the compounds provided herein including embodiments thereof, electrolytes, alkali and polymers. In contrast, a “macroemulsion” as referred to herein is a thermodynamically unstable mixture of oil and water that may also include additional components. The emulsion composition provided herein may be an oil-in-water emulsion, wherein the surfactant forms aggregates (e.g. micelles) where the hydrophilic part of the surfactant molecule contacts the aqueous phase of the emulsion and the lipophilic part contacts the oil phase of the emulsion. Thus, in embodiments, the surfactant forms part of the aqueous part of the emulsion. And in embodiments, the surfactant forms part of the oil phase of the emulsion. In yet another embodiment, the surfactant forms part of an interface between the aqueous phase and the oil phase of the emulsion.

The emulsions may have the same pH as set forth above in the context of the aqueous compositions provided herein. Thus, in embodiments, the pH of the emulsion is at least about 9. In embodiments, the pH of the emulsion is at least about 10. In embodiments, the pH of the emulsion is at least about 11. Where an emulsion has a pH, it is understood that the pH is within the hydrophilic (e.g. aqueous) portion.

In embodiments, the oil and water solubilization ratios are insensitive to the combined concentration of multivalent mineral cations (e.g. Ca⁺² and Mg⁺²) within the emulsion composition. In embodiments, the oil and water solubilization ratios are insensitive to the salinity of the water or to all of the specific electrolytes contained in the water. The term “insensitive” used in the context of this paragraph means that the solubilization ratio tends not to change (e.g. tends to remain approximately constant) as the concentration of multivalent mineral cations and/or salinity of water changes. In embodiments, the change in the solubilization ratios are less than 5%, 10%, 20%, 30%, 40%, or 50% over a multivalent mineral cation (e.g. divalent metal cation) concentration range of 10 ppm, 100 ppm, 1000 ppm or 10,000 ppm. In another embodiment, the change in the solubilization ratios are less than 5%, 10%, 20%, 30%, 40%, or 50% over a salinity concentration range of 10 ppm, 100 ppm, 1000 ppm or 10,000 ppm.

In embodiments, the pH of the emulsion composition is insensitive to the combined concentration of multivalent mineral cations (e.g. Ca⁺² and Mg⁺²) within the emulsion composition. In embodiments, the pH is insensitive to the concentration of multivalent mineral cation (e.g. derived or dissolved from gypsum) contained in the emulsion composition. The term “insensitive” used in the context of this paragraph means that the pH tends not to change (e.g. tends to remain approximately constant) as the concentration of multivalent metal cations (e.g. derived or dissolved from a sulfate mineral) changes. In embodiments, the change in the pH is less than 5%, 10%, 20%, 30%, 40%, or 50% over a divalent metal cation concentration range of 10 ppm, 100 ppm, 1000 ppm or 10,000 ppm. In another embodiment, the change in pH is less than 5%, 10%, 20%, 30%, 40%, or 50% over a concentration range of 10 ppm, 100 ppm, 1000 ppm or 10,000 ppm of multivalent mineral cation.

### 3. Methods

In another aspect, a method of displacing an unrefined petroleum material in contact with a solid material is provided. The method includes contacting an unrefined petroleum material with an aqueous composition as provided herein. The unrefined petroleum material is in contact with a solid material comprising a mineral, wherein water dissolves multivalent mineral cations from the mineral. The unrefined petroleum material is allowed to separate from the solid material thereby displacing the unrefined petroleum material in contact with the solid material.

In embodiments, the aqueous composition includes the components, and amounts thereof, set forth above in the description of the aqueous solution (e.g. an aqueous composition including an alkoxy sulfate surfactant, wherein the alkoxy sulfate surfactant is C₁₃-13PO-sulfate, an olefin sulfonate surfactant, wherein the olefin sulfonate surfactant is C₁₉-C₂₃ IOS, a co-solvent, wherein the co-solvent is isobutyl alcohol, a boron oxygenate, wherein the boron oxygenate is sodium metaborate, a viscosity enhancing water soluble polymer, wherein the polymer is 3330S Flopaam and a multivalent mineral cation derived or dissolved from a sulfate mineral, wherein the sulfate mineral is gypsum (Ca²⁺). Thus, in embodiments, the surfactant is an anionic surfactant, a non-ionic surfactant, a zwitterionic surfactant or a cationic surfactant. In embodiments, the anionic surfactant is an alkoxy carboxylate surfactant, an alkoxy sulfate surfactant, an alkoxy sulfonate surfactant, an alkyl sulfonate surfactant, an aryl sulfonate surfactant or an olefin sulfonate surfactant. In embodiments, the surfactant is present at a concentration of at least 0.1% w/w (e.g. 0.4% w/w, 0.6% w/w). As described above the boron oxygenate may be present in the aqueous composition (or emulsion composition) in an amount sufficient to increase the solubility of the surfactant. In embodiments, the boron oxygenate is present in an amount sufficient to increase the solubility of the surfactant in the emulsion composition relative to the absence of the boron oxygenate. In embodiments, the boron oxygenate is present in an amount sufficient to decrease the adsorption of the surfactant to the solid material in a petroleum reservoir relative to the absence of the boron oxygenate. In embodiments, the boron oxygenate (e.g. sodium metaborate) is present at a concentration of at least 0.1% w/w (e.g. 3.75% w/w).

In embodiments, the aqueous composition includes a viscosity enhancing water soluble polymer. In embodiments, the aqueous composition includes a co-solvent. In embodiments, the aqueous composition includes a gas. In embodiments, the water is soft brine water.

In embodiments, the method includes contacting the solid material with the boron oxygenate. In embodiments, the solid material is a endogenous (also referred to herein as “natural”) solid material (i.e. a solid found in nature such as rock). In embodiments, the natural solid material is rock or regolith. The natural solid material may be a geological formation such as clastics or carbonates. The natural solid material may be either consolidated or unconsolidated material or mixtures thereof. The unrefined petroleum material may be trapped or confined by “bedrock” above or below the natural solid material. The unrefined petroleum material may be found in fractured bedrock or porous natural solid material. In embodiments, the regolith is soil. In embodiments, the rock includes a sulfate mineral. In embodiments, the sulfate mineral is gypsum.

In embodiments, the solid material is a natural solid material in a petroleum reservoir. In embodiments, the method is an enhanced oil recovery method. Enhanced oil recovery methods are well known in the art. A general treatise on enhanced oil recovery methods is Basic Concepts in Enhanced Oil Recovery Processes edited by M. Baviere (published for SCI by Elsevier Applied Science, London and New York, 1991). For example, in an enhanced oil recovery method, the displacing of the unrefined petroleum in contact with the solid material is accomplished by contacting the unrefined petroleum with an aqueous composition provided herein (e.g. an aqueous composition including an alkoxy sulfate surfactant, wherein the alkoxy sulfate surfactant is C₁₃-13PO-sulfate, an olefin sulfonate surfactant, wherein the olefin sulfonate surfactant is C₁₉-C₂₃ IOS, a co-solvent, wherein the co-solvent is isobutyl alcohol, a boron oxygenate, wherein the boron oxygenate is sodium metaborate, a polymer, wherein the polymer is 3330S Flopaam and a multivalent mineral cation derived or dissolved from a sulfate mineral, wherein the sulfate mineral is gypsum), wherein the unrefined petroleum is in contact with the solid material. The unrefined petroleum may be in an oil reservoir. The aqueous composition provided herein is pumped into the reservoir in accordance with known enhanced oil recovery parameters. The aqueous composition provided herein may be pumped into the reservoir and, upon contacting the unrefined petroleum, form an emulsion composition provided herein.

In embodiments, an emulsion forms after the contacting. The emulsion thus formed may be the emulsion composition as described above. In embodiments, the method includes allowing an unrefined petroleum acid within the unrefined petroleum material to enter into the emulsion (e.g. emulsion composition), thereby converting the unrefined petroleum acid into a surfactant. In other words, where the unrefined petroleum acid converts into a surfactant it is mobilized and therefore separates from the solid material. In embodiments, the multivalent mineral cation forms part of the emulsion. In embodiments, the multivalent mineral cation is dissolved or derived from gypsum.

In another aspect, a method of converting an unrefined petroleum acid into a surfactant is provided. The method includes contacting a petroleum material with an aqueous composition as provided herein, thereby forming an emulsion in contact with the petroleum material. The unrefined petroleum acid within the unrefined petroleum material is allowed to enter into the emulsion, thereby converting the unrefined petroleum acid into a surfactant. The aqueous composition may be, e.g., an aqueous composition including an alkoxy sulfate surfactant, wherein the alkoxy sulfate surfactant is C₁₃-13PO-sulfate present, an olefin sulfonate surfactant, wherein the olefin sulfonate surfactant is C₁₉-C₂₃ IOS, a co-solvent, wherein the co-solvent is isobutyl alcohol, sodium metaborate, a polymer, wherein the polymer is 3330S Flopaam and a multivalent mineral cation derived or dissolved from a sulfate mineral, wherein the sulfate mineral is gypsum. In embodiments, the reactive petroleum material is in a petroleum reservoir. In embodiments of the methods and compositions provided herein, as described above and as is generally known in the art, the unrefined petroleum acid is a naphthenic acid. In embodiments, as described above and as is generally known in the art, the unrefined petroleum acid is a mixture of naphthenic acids.

### 4. Examples

The following examples are meant to provide detailed embodiments only and are not meant to limit the scope of the disclosure provided herein in any way.

Phase Behavior Procedures

Phase Behavior Screening: Phase behavior studies have been used to characterize chemicals for EOR. There are many benefits in using phase behavior as a screening method. Phase Behavior studies are used to determine: (1) the effect of electrolytes; (2) oil solubilization and IFT reduction, (3) microemulsion densities; (4) microemulsion viscosities; (5) coalescence times; (6) optimal co-solvent/alkali agent formulations; and/or (7) optimal properties for recovering oil from cores and reservoirs.

Thermodynamically stable phases can form with oil, water and aqueous mixtures. In situ generated soaps form micellar structures at concentrations at or above the critical micelle concentration (CMC). The emulsion coalesces into a separate phase at the oil-water interface and is referred to as a microemulsion. A microemulsion is a surfactant-rich distinct phase consisting of in situ generated soaps, oil and water and co-solvent, alkali agent and other components. This phase is thermodynamically stable in the sense that it will return to the same phase volume at a given temperature. Some workers in the past have added additional requirements, but for the purposes of this engineering study, the only requirement will be that the microemulsion is a thermodynamically stable phase.

The phase transition is examined by keeping all variables fixed except for the scanning variable. The scan variable is changed over a series of pipettes and may include, but is not limited to, salinity, temperature, chemical (co-solvent, alcohol, electrolyte), oil, which is sometimes characterized by its equivalent alkane carbon number (EACN), and co-solvent structure, which is sometimes characterized by its hydrophilic-lipophilic balance (HLB). The phase transition was first characterized by Winsor (1954) into three regions: Type I—excess oil phase, Type III—aqueous, microemulsion and oil phases, and the Type II—excess aqueous phase. The phase transition boundaries and some common terminology are described as follows: Type I to III—lower critical salinity, Type III to II—upper critical salinity, oil solubilization ratio (Vo/Vs), water solubilization ratio (Vw/Vs), the solubilization value where the oil and water solubilization ratios are equal is called the Optimum Solubilization Ratio (σ*), and the electrolyte concentration where the optimum solubilization ratio occurs is referred to as the Optimal Salinity (S*). Since no surfactant is added, the only surfactant present is the in-situ generated soap. For the purpose of calculating a solubilization ratio, one can assume a value for soap level using TAN (total acid number) and an approximate molecular weight for the soap.

Determining Interfacial Tension

Efficient use of time and lab resources can lead to valuable results when conducting phase behavior scans. A correlation between oil and water solubilization ratios and interfacial tension was suggested by Healy and Reed (1976) and a theoretical relationship was later derived by Chun Huh (1979). Lowest oil-water IFT occurs at optimum solubilization as shown by the Chun Huh theory. This is equated to an interfacial tension through the Chun Huh equation, where IFT varies with the inverse square of the solubilization ratio:

$$γ = \frac{C}{{σ}^{2}} \qquad ( 1 )$$

For most crude oils and microemulsions, C=0.3 is a good approximation. Therefore, a quick and convenient way to estimate IFT is to measure phase behavior and use the Chun-Huh equation to calculate IFT. The IFT between microemulsions and water and/or oil can be very difficult and time consuming to measure and is subject to larger errors, so using the phase behavior approach to screen hundreds of combinations of co-solvents, electrolytes, oil, and so forth is not only simpler and faster, but avoids the measurement problems and errors associated with measuring IFT especially of combinations that show complex behavior (gels and so forth) and will be screened out anyway. Once a good formulation has been identified, then it is still a good idea to measure IFT.

Equipment

Phase behavior experiments are created with the following materials and equipment.

Mass Balance: Mass balances are used to measure chemicals for mixtures and determine initial saturation values of cores.

Water Deionizer: Deionized (DI) water is prepared for use with all the experimental solutions using a Nanopure™ filter system. This filter uses a recirculation pump and monitors the water resistivity to indicate when the ions have been removed. Water is passed through a 0.45 micron filter to eliminate undesired particles and microorganisms prior to use.

Borosilicate Pipettes: Standard 5 mL borosilicate pipettes with 0.1 mL markings are used to create phase behavior scans as well as run dilution experiments with aqueous solutions. Ends are sealed using a propane and oxygen flame.

Pipette Repeater: An Eppendorf Repeater Plus® instrument is used for most of the pipetting. This is a handheld dispenser calibrated to deliver between 25 microliter and 1 ml increments. Disposable tips are used to avoid contamination between stocks and allow for ease of operation and consistency.

Propane-oxygen Torch: A mixture of propane and oxygen gas is directed through a Bernz-O-Matic flame nozzle to create a hot flame about ½ inch long. This torch is used to flame-seal the glass pipettes used in phase behavior experiments.

Convection Ovens: Several convection ovens are used to incubate the phase behaviors and core flood experiments at the reservoir temperatures. The phase behavior pipettes are primarily kept in Blue M and Memmert ovens that are monitored with mercury thermometers and oven temperature gauges to ensure temperature fluctuations are kept at a minimal between recordings. A large custom built flow oven was used to house most of the core flood experiments and enabled fluid injection and collection to be done at reservoir temperature.

pH Meter: An ORION research model 701/digital ion analyzer with a pH electrode is used to measure the pH of most aqueous samples to obtain more accurate readings. This is calibrated with 4.0, 7.0 and 10.0 pH solutions. For rough measurements of pH, indicator papers are used with several drops of the sampled fluid.

Phase Behavior Calculations

The oil and water solubilization ratios are calculated from interface measurements taken from phase behavior pipettes. These interfaces are recorded over time as the mixtures approached equilibrium and the volume of any macroemulsions that initially formed decreased or disappeared.

Phase Behavior Methodology

The methods for creating, measuring and recording observations are described in this section. Scans are made using a variety of electrolyte mixtures described below. Oil is added to most aqueous surfactant solutions to see if a microemulsion formed, how long it took to form and equilibrate if it formed, what type of microemulsion formed and some of its properties such as viscosity. However, the behavior of aqueous mixtures without oil added is also important and is also done in some cases to determine if the aqueous solution is clear and stable over time, becomes cloudy or separated into more than one phase.

Preparation of samples. Phase behavior samples are made by first preparing surfactant aqueous stock solutions and combining them with brine stock solutions in order to observe the behavior of the mixtures over a range of salinities.

Solution Preparation. Surfactant aqueous stock solutions are based on active weight-percent co-solvent. The masses of co-solvent, alkali agent and de-ionized water (DI) are measured out on a balance and mixed in glass jars using magnetic stir bars. The order of addition is recorded on a mixing sheet along with actual masses added and the pH of the final solution. Brine solutions are created at the necessary weight percent concentrations for making the scans.

Co-solvent Stock. The chemicals being tested are first mixed in a concentrated stock solution that usually consisted of co-solvent, alkali agent and/or polymer along with de-ionized water. The quantity of chemical added is calculated based on activity and measured by weight percent of total solution. Initial experiments are at about 1-3% co-solvent so that the volume of the middle microemulsion phase would be large enough for accurate measurements assuming a solubilization ratio of at least 10 at optimum salinity.

Polymer Stock. Often these stocks were quite viscous and made pipetting difficult so they are diluted with de-ionized water accordingly to improve ease of handling. Mixtures with polymer are made only for those co-solvent formulations that showed good behavior and merited additional study for possible testing in core floods. Consequently, scans including polymer are limited since they are done only as a final evaluation of compatibility with the co-solvent.

Pipetting Procedure. Phase behavior components are added volumetrically into 5 ml pipettes using an Eppendorf Repeater Plus or similar pipetting instrument. Co-solvent, alkali agent and brine stocks are mixed with DI water into labeled pipettes and brought to temperature before agitation. Almost all of the phase behavior experiments are initially created with a water oil ratio (WOR) of 1:1, which involves mixing 2 ml of the aqueous phase with 2 ml of the evaluated crude oil or hydrocarbon, and different WOR experiments are mixed accordingly. The typical phase behavior scan consisted of 10-20 pipettes, each pipette being recognized as a data point in the series.

Order of Addition. Consideration must be given to the addition of the components since the concentrations are often several folds greater than the final concentration. Therefore, an order is established to prevent any adverse effects resulting from co-solvent, alkali agent or polymer coming into direct contact with the concentrated electrolytes. The desired sample compositions are made by combining the stocks in the following order: (1) Electrolyte stock(s); (2) De-ionized water; (3) co-solvent stock; (4) alkali agent stock; (5) Polymer stock; and (6) Crude oil or hydrocarbon.

Initial Observations. Once the components are added to the pipettes, sufficient time is allotted to allow all the fluid to drain down the sides. Then aqueous fluid levels are recorded before the addition of oil. These measurements are marked on record sheets. Levels and interfaces are recorded on these documents with comments over several days and additional sheets are printed as necessary.

Sealing and Mixing. The pipettes are blanketed with argon gas to prevent the ignition of any volatile gas present by the flame sealing procedure. The tubes are then sealed with the propane-oxygen torch to prevent loss of additional volatiles when placed in the oven. Pipettes are arranged on the racks to coincide with the change in the scan variable. Once the phase behavior scan is given sufficient time to reach reservoir temperature (15-30 minutes), the pipettes are inverted several times to provide adequate mixing. Tubes are observed for low tension upon mixing by looking at droplet size and how uniform the mixture appeared. Then the solutions are allowed to equilibrate over time and interface levels are recorded to determine equilibration time and co-solvent/alkali agent performance.

Measurements and Observations. Phase behavior experiments are allowed to equilibrate in an oven that is set to the reservoir temperature for the crude oil being tested. The fluid levels in the pipettes are recorded periodically and the trend in the phase behavior observed over time. Equilibrium behavior is assumed when fluid levels ceased to change within the margin of error for reading the samples.

Fluid Interfaces. The fluid interfaces are the most crucial element of phase behavior experiments. From them, the phase volumes are determined and the solubilization ratios are calculated. The top and bottom interfaces are recorded as the scan transitioned from an oil-in-water microemulsion to a water-in-oil microemulsion. Initial readings are taken one day after initial agitation and sometimes within hours of agitation if coalescence appeared to happen rapidly. Measurements are taken thereafter at increasing time intervals (for example, one day, four days, one week, two weeks, one month and so on) until equilibrium is reached or the experiment is deemed unessential or uninteresting for continued observation.

In the process of conducting chemical EOR in the oil field under alkaline conditions, the presence of gypsum or anhydrite (calcium sulfate) in the rock surface (e.g. petroleum bearing porous rock) makes the use of conventional alkalis ineffective. Common alkalis such as sodium carbonate are ineffective when calcium sulfate is present due to rapid precipitation of calcium carbonate adversely affecting the propagation of high pH, which is essential to minimizing the surfactant adsorption onto the rock, generating soap from active oils and stabilizing surfactants (e.g. anionic sulfate surfactants) at high temperature. The surfactant performance (and thermal stability in the case of anionic sulfate surfactants) may also be affected. Applicants have surprisingly discovered that boron oxygenates (e.g. sodium metaborate) maintain a high pH profile in solution in the presence of minerals that solubilize in water to produce multivalent mineral cations (e.g. gypsum) and such high pH will propagate in rock containing those minerals. For example, Applicants have repeatedly performed successful corefloods using reservoir rocks containing gypsum using ASP formulations where the alkalinity was provided by the metaborate and the propagation of high pH in the core was observed. As a result, the oil recovery was excellent with minimal surfactant retention in the rock. The analyses of the effluents from the corefloods clearly show that while there was some interaction between the CaSO₄ and sodium metaborate, it is minimal and therefore tolerable for the pH propagation and without producing adverse consequences such as high pressure gradients caused by precipitation and plugging.

For the success of an alkali-surfactant-polymer (ASP) (or alkali-co-solvent-polymer (ACP), alkali-polymer (AP), alkali-co-solvent (AC) or alkali (A) systems) process in recovering oil from reservoirs, the pH should be able to propagate in the reservoir without interacting significantly with reservoir minerals. Gypsum or anhydrite (depending on the reservoir temperature), is a commonly occurring mineral in oil reservoirs, both sandstones and carbonates. In the presence of gypsum or anhydrite, conventional alkalis such as sodium carbonate cannot be used for chemical EOR (e.g. ASP, ACP, AP, A) processes because of its interaction with these minerals leading to slug degradation and changes in permeability, among other damages. In this work, sodium metaborate has been shown as an alternative alkali in the presence of gypsum or anhydrite in oil reservoirs.

In the following set of experiments (Table 1), the effect of gypsum on pH of various alkalis was studied. The results presented below are for sodium carbonate and sodium metaborate which shows that sodium metaborate is able to maintain a pH above 10 in the presence of excess gypsum. Sodium carbonate, on the other hand, failed completely to maintain it, although the starting pH of sodium carbonate solutions is more than 11 at this concentration.

TABLE 1
Static experiment pH data of sodium metaborate solutions and sodium
carbonate solution in the presence of lab grade CaSO₄•2H₂O at
53 degree C.

| | | | | pH | pH |
|---|---|---|---|---|---|
| Sam- | | | NaCl | (after | (after |
| ple | Alkali | CaSO₄•2H₂O | (ppm) | 2 days) | 11 days) |
| 1 | 0.45M NaBO2 | 1M | 10000 | 10.90 | 10.93 |
| 2 | 0.15M NaBO2 | 1M | 10000 | 10.42 | 10.44 |
| 3 | 0.45M Na2CO3 | 1M | 10000 | 8.11 | 8.11 |
| 4 | Blank-10000 ppm | 1M | 10000 | 6.81 | 6.89 |
| | NaCl | | | | |
| 5 | 0.45M NaBO2 | 1M | 80000 | 10.46 | 10.53 |

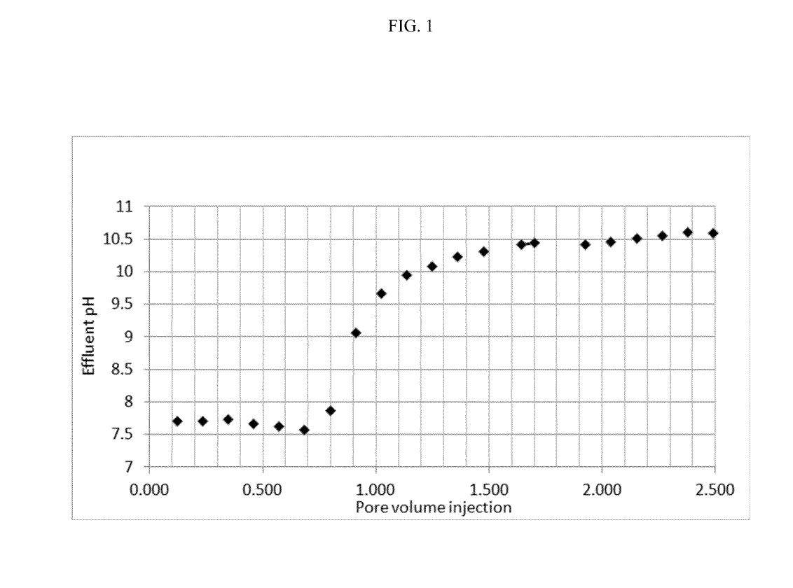

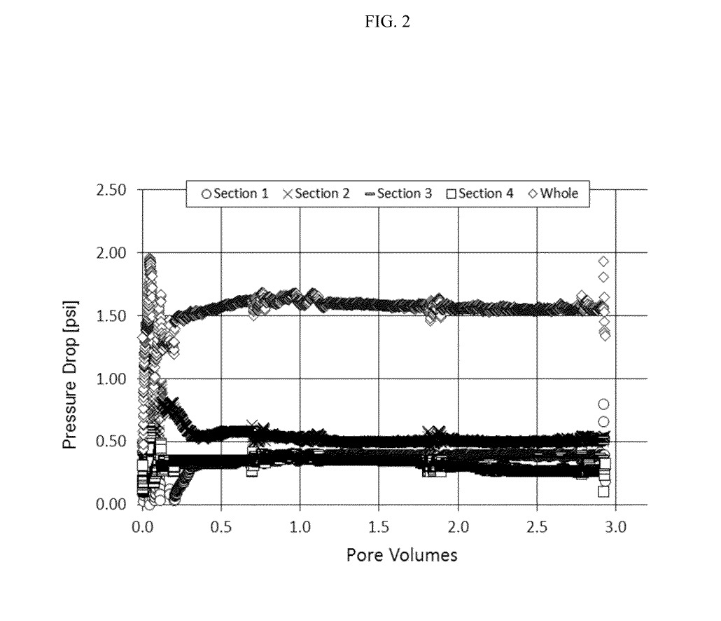

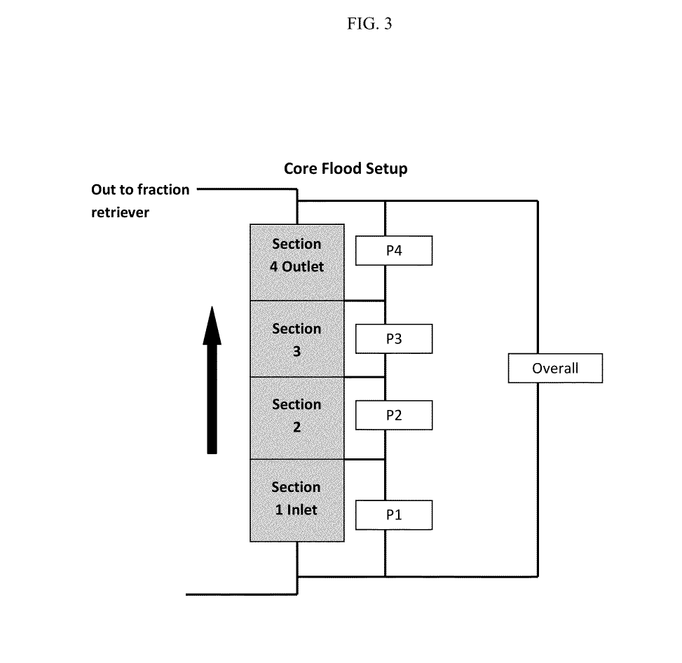

In order to test the effectiveness of sodium metaborate in propagating through the reservoir, dynamic tests were performed where 0.45M solutions of sodium metaborate were displaced through various sandstone and carbonate cores that had gypsum present. The results presented below (FIG. 1-3) show the effluent pH profile and the pressure drop data during the injection of 3% solution of sodium metaborate with 8% NaCl brine in a 1 ft long sandstone core having gypsum. FIG. 3 shows the positions of the pressure transducers. Prior to this injection, 8% NaCl brine was present in the core. It shows that the pH of the effluent gets close to the injected pH in about 1.5 PV injected. Pressure drop does not change with injection indicating no large precipitation or dissolution.

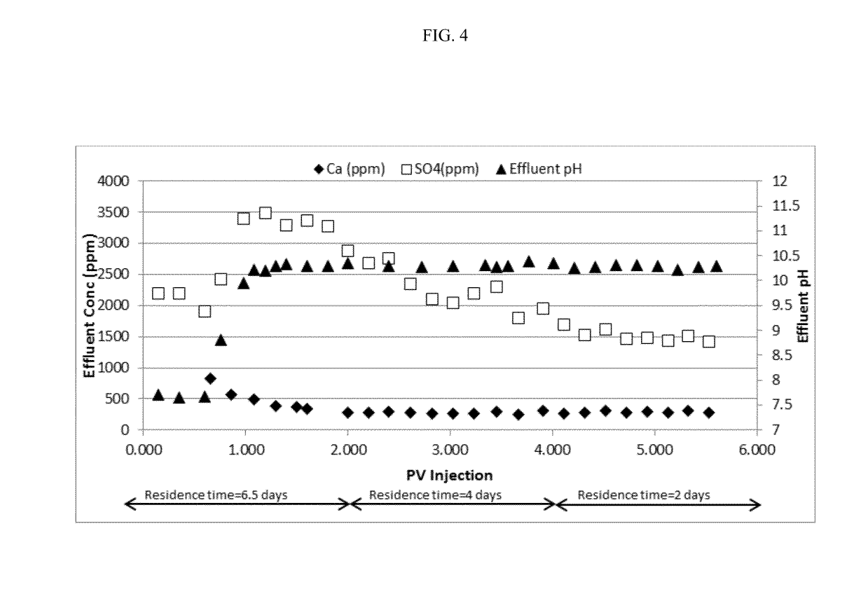

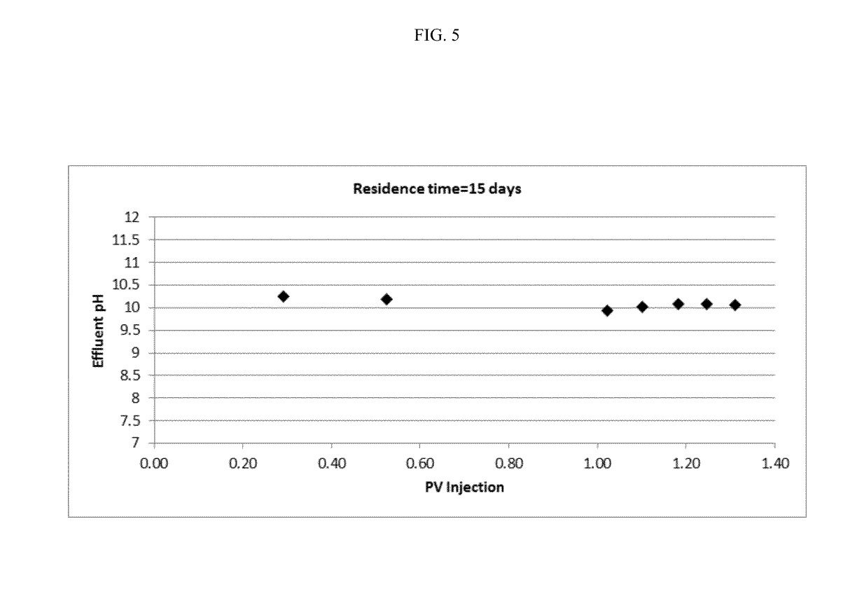

The results shown in FIGS. 4 and 5 are for a carbonate core where 0.45M sodium metaborate solution was displaced at various flow rates since the residence time in an actual reservoir is larger than 1 day (typical for lab experiments). The minimum flow rate is for 15 days residence time to study near well flow characteristics. The effluent pH in all the cases was more than 10 and the effects on permeability were negligible. The presence of sulfate and calcium in the effluent samples indicate the presence of gypsum in the core.

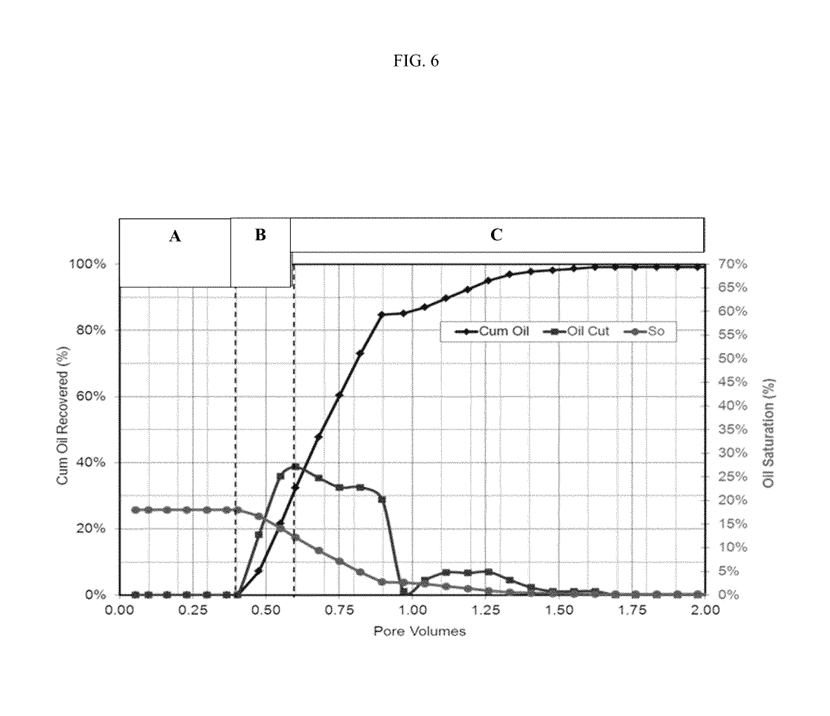

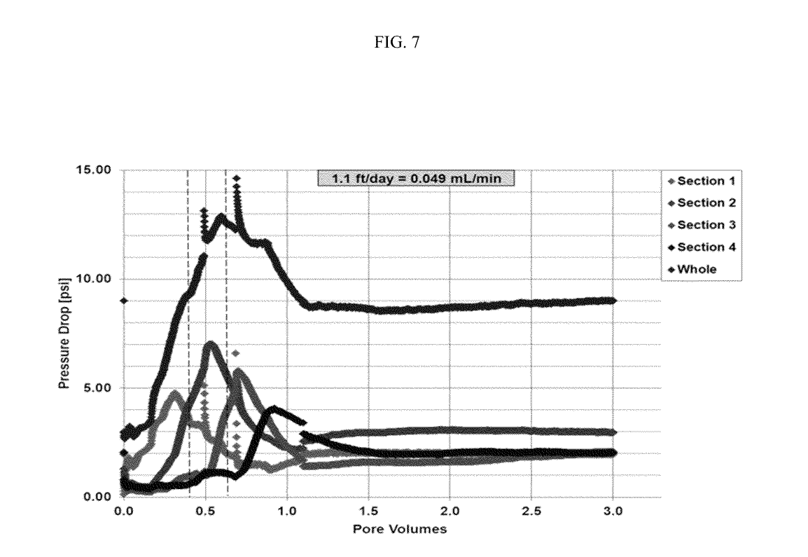

In the following section, the results of a tertiary ASP coreflood performed on a 1 ft long core having gypsum are presented. The oil recovery data are given in FIG. 6 and the pressure drop data is given in FIG. 7. The results show 98% oil recovery without noticeable changes in permeability with sodium metaborate in the presence of gypsum. The residence time was 1 day in this coreflood. Further another ASP coreflood was performed with a residence time of 4 days and a good oil recovery was observed without changes in permeability. The surfactant retention in all these cases was very low.

### 5. Embodiments

### Embodiment 1

An aqueous composition comprising water, a surfactant, a boron oxygenate and a multivalent mineral cation.

### Embodiment 2

The aqueous composition of embodiment 1, further comprising a co-solvent.

### Embodiment 3

An aqueous composition comprising water, a co-solvent, a boron oxygenate and a multivalent mineral cation.

### Embodiment 4

The aqueous composition of embodiment 3, further comprising a surfactant.

### Embodiment 5

The aqueous composition of one of embodiments 1 to 4, wherein said aqueous composition is within a petroleum reservoir.

### Embodiment 6

The aqueous composition of one of embodiments 1 to 5 wherein said aqueous composition has a pH of at least about 9.

### Embodiment 7

The aqueous composition of one of embodiments 1 to 6, wherein said aqueous composition is in contact with a mineral, wherein water dissolves said multivalent mineral cation from said mineral.

### Embodiment 8

The aqueous composition of embodiment 7, wherein said mineral is a sulfate mineral.

### Embodiment 9

The aqueous composition of embodiment 7, wherein said mineral is gypsum, anhydrite, barite or magnesium sulfate.

### Embodiment 10

The aqueous composition of one of embodiments 1 to 9, wherein said boron oxygenate is a metaborate or a borax.

### Embodiment 11

The aqueous composition of one of embodiments 1 to 9, wherein said boron oxygenate is borax.

### Embodiment 12

The aqueous composition of embodiment 11, wherein said aqueous composition further comprises sodium silicate, potassium hydroxide or sodium hydroxide.

### Embodiment 13

The aqueous composition of one of embodiments 1 to 9, wherein said boron oxygenate is sodium metaborate.

### Embodiment 14

The aqueous composition of one of embodiments 1 to 13, wherein said multivalent mineral cation is an alkaline earth metal cation.

### Embodiment 15

The aqueous composition of one of embodiments 1 to 13, wherein said multivalent mineral cation is Fe³⁺, Ca²⁺, Mg²⁺, Sr²⁺, Ba²⁺ or Be²⁺.

### Embodiment 16

The aqueous composition of one of embodiments 1, 2, or 4 to 15, wherein said surfactant is an anionic surfactant, a non-ionic surfactant, a zwitterionic surfactant or a cationic surfactant.

### Embodiment 17

The aqueous composition of one of embodiments 1, 2, or 4 to 16, wherein said anionic surfactant is an alkoxy carboxylate surfactant, an alkoxy sulfate surfactant, an alkoxy sulfonate surfactant, an alkyl sulfonate surfactant, an aryl sulfonate surfactant or an olefin sulfonate surfactant.

### Embodiment 18

The aqueous composition of one of embodiments 1, 2, or 4 to 17, wherein said surfactant is present at a concentration of at least 0.1% w/w.

### Embodiment 19

The aqueous composition of one of embodiments 1, 2, or 4 to 18, wherein said boron oxygenate is present in an amount sufficient to increase the solubility of said surfactant in said aqueous composition relative to the absence of said sodium metaborate.

### Embodiment 20

The aqueous composition of one of embodiments 1 to 19, wherein said boron oxygenate is present at a concentration of at least 0.1% w/w.

### Embodiment 21

The aqueous composition of one of embodiments 1 to 20, further comprising a viscosity enhancing water soluble polymer.

### Embodiment 22

The aqueous composition of embodiment 21, wherein said viscosity enhancing water soluble polymer is polyacrylamide or a co-polymer of polyacrylamide.

### Embodiment 23

The aqueous composition of embodiment 21, wherein said viscosity enhancing water soluble polymer is a hydrolyzed polymer.

### Embodiment 24

The aqueous composition of embodiment 21, wherein said viscosity enhancing water soluble polymer is a biopolymer.

### Embodiment 25

The aqueous composition of embodiment 24, wherein said biopolymer is xanthan gum or scleroglucan.

### Embodiment 26

The aqueous composition of one of embodiments 1 to 20, further comprising a gas.

### Embodiment 27

The aqueous composition of one of embodiments 1 to 26, wherein said water is soft brine water.

### Embodiment 28

The aqueous composition of one of embodiments 1 to 27, having a salinity of at least 5,000 ppm.

### Embodiment 29

The aqueous composition of one of embodiments 1 to 27, having a salinity of at least 10,000 ppm.

### Embodiment 30

The aqueous composition of one of embodiments 1 to 27, having a salinity of at least 50,000 ppm.

### Embodiment 31

The aqueous composition of one of embodiments 1 to 27, having a salinity of at least 100,000 ppm.

### Embodiment 32

The aqueous composition of one of embodiments 1 to 27, having a salinity of at least 150,000 ppm.

### Embodiment 33

The aqueous composition of one of embodiments 1 to 32, having a pH of about 10.

### Embodiment 34

The aqueous composition of one of embodiments 1 to 32, having a pH of about 11.

### Embodiment 35

An aqueous composition comprising water, a hydrolyzed or partially hydrolyzed viscosity enhancing water soluble polymer and a boron oxygenate at a pH of at least about 9.

### Embodiment 36

An emulsion composition comprising an unrefined petroleum, water, a surfactant, a boron oxygenate and a multivalent mineral cation.

### Embodiment 37

The emulsion of embodiment 36, further comprising a co-solvent.

### Embodiment 38

An emulsion composition comprising an unrefined petroleum, water, a co-solvent, a boron oxygenate and a multivalent mineral cation.

### Embodiment 39

The emulsion of embodiment 37, further comprising a surfactant.

### Embodiment 40

The emulsion of one of embodiments 36 to 39, wherein said emulsion is within a petroleum reservoir.

### Embodiment 41

The emulsion of one of embodiments 36 to 40, wherein said emulsion has a pH of at least about 9.

### Embodiment 42

The emulsion of one of embodiments 36 to 40, wherein said emulsion is in contact with a mineral, wherein water dissolves said multivalent mineral cation from said mineral.

### Embodiment 43

The emulsion of embodiment 42, wherein said mineral is a sulfate mineral.

### Embodiment 44

The emulsion of embodiment 42, wherein said mineral is gypsum, anhydrite, barite or magnesium sulfate.

### Embodiment 45

The emulsion of one of embodiments 36 to 44, wherein said boron oxygenate is a metaborate or a borax.

### Embodiment 46

The emulsion of embodiment 45, wherein said boron oxygenate is borax

### Embodiment 47

The emulsion of embodiment 46, wherein said emulsion further comprises sodium silicate, potassium hydroxide or sodium hydroxide. The emulsion of embodiment 46, wherein said emulsion further comprises sodium silicate.

### Embodiment 48

The emulsion of one of embodiments 36 to 44, wherein said boron oxygenate is sodium metaborate.

### Embodiment 49

The emulsion of one of embodiments 36 to 49, wherein said multivalent mineral cation is an alkaline earth metal cation.

### Embodiment 50

The emulsion of one of embodiments 36 to 49, wherein said multivalent mineral cation is an alkaline earth metal cation.

### Embodiment 51

The emulsion of one of embodiments 36, 37, or 39 to 50, wherein said surfactant is an anionic surfactant, a non-ionic surfactant, a zwitterionic surfactant or a cationic surfactant.

### Embodiment 52

The emulsion of one of embodiments 36, 37, or 39 to 51, wherein said anionic surfactant is an alkoxy carboxylate surfactant, an alkoxy sulfate surfactant, an alkoxy sulfonate surfactant, an alkyl sulfonate surfactant, an aryl sulfonate surfactant or an olefin sulfonate surfactant.

### Embodiment 53

The emulsion of one of embodiments 36, 37, or 39 to 52, wherein said surfactant is present at a concentration of at least 0.1% w/w.

### Embodiment 54

The emulsion of one of embodiments 36, 37, or 39 to 53, wherein said boron oxygenate is present in an amount sufficient to increase the solubility of said surfactant in said emulsion composition relative to the absence of said boron oxygenate.

### Embodiment 55

The emulsion of one of embodiments 36 to 54, wherein said boron oxygenate is present at a concentration of at least 0.1% w/w.

### Embodiment 56

The emulsion of one of embodiments 36 to 55, further comprising a viscosity enhancing water soluble polymer.

### Embodiment 57

The emulsion composition of embodiment 56, wherein said viscosity enhancing water soluble polymer is polyacrylamide or a co-polymer of polyacrylamide.

### Embodiment 58

The emulsion composition of embodiment 56, wherein said viscosity enhancing water soluble polymer is a hydrolyzed polymer.

### Embodiment 59

The emulsion of one of embodiments 37 to 57, further comprising a co-solvent.

### Embodiment 60

The emulsion of one of embodiments 36 to 59, further comprising a gas.

### Embodiment 61

The emulsion of one of embodiments 36 to 60, wherein said water is soft brine water.

### Embodiment 62

The emulsion of one of embodiments 36 to 60, wherein the oil and water solubilization ratios are insensitive to the combined concentration of multivalent mineral cations combined within the aqueous phase.

### Embodiment 63

The emulsion of one of embodiments 36 to 62, wherein the emulsion composition is a microemulsion.

### Embodiment 64

A method of displacing an unrefined petroleum material in contact with a solid material, said method comprising: (i) contacting an unrefined petroleum material with an aqueous composition as in any one of embodiments 1-35, wherein said unrefined petroleum material is in contact with a solid material comprising a mineral, wherein water dissolves multivalent mineral cations from said mineral; (ii) allowing said unrefined petroleum material to separate from said solid material thereby displacing said unrefined petroleum material in contact with said solid material.

### Embodiment 65

The method of embodiment 64, further comprising contacting said solid material with said boron oxygenate.

### Embodiment 66

The method of embodiment 64, wherein said solid material is an endogenous solid material in a petroleum reservoir.

### Embodiment 67

The method of embodiment 64, wherein said method is an enhanced oil recovery method.

### Embodiment 68

The method of embodiment 64, wherein an emulsion forms after said contacting.

### Embodiment 69

The method of embodiment 64, wherein said mineral is gypsum, anhydrite, barite or magnesium sulfate.

### Embodiment 70

A method of converting an unrefined petroleum acid into a surfactant, said method comprising: (i) contacting a petroleum material with an aqueous composition as in any one of embodiments 1-35, thereby forming an emulsion in contact with said petroleum material; (ii) allowing an unrefined petroleum acid within said unrefined petroleum material to enter into said emulsion, thereby converting said unrefined petroleum acid into a surfactant.

### Embodiment 71

The method of embodiment 70, wherein said reactive petroleum material is in a petroleum reservoir.

### Embodiment 72

An aqueous composition comprising water, a hydrolyzed or partially hydrolyzed viscosity enhancing water soluble polymer and a boron oxygenate at a pH of at least about 9.

### Embodiment 73

The aqueous composition of embodiment 72, wherein said hydrolyzed viscosity enhancing water soluble polymer is a hydrolyzed or partially hydrolyzed polyacrylamide.

What is claimed is:

1. An aqueous composition comprising water, a surfactant, a boron oxygenate and a multivalent mineral cation.

2. The aqueous composition of claim 1, further comprising a co-solvent.

3. The aqueous composition of claim 1, wherein said aqueous composition is within a petroleum reservoir.

4. The aqueous composition of claim 1, wherein said aqueous composition has a pH of at least about 9.

5. The aqueous composition of claim 1, wherein said aqueous composition is in contact with a mineral, wherein water dissolves said multivalent mineral cation from said mineral.

6. The aqueous composition of claim 5, wherein said mineral is gypsum, anhydrite, barite or magnesium sulfate.

7. The aqueous composition of claim 1, wherein said boron oxygenate is a metaborate or a borax.

8. The aqueous composition of claim 7, wherein said aqueous composition further comprises sodium silicate, potassium hydroxide or sodium hydroxide.

9. The aqueous composition of claim 1, wherein said multivalent mineral cation is Fe³⁺, Ca²⁺, Mg²⁺, Sr²⁺, Ba²⁺ or Be²⁺.

10. The aqueous composition of claim 1, wherein said surfactant is an anionic surfactant, a non-ionic surfactant, a zwitterionic surfactant or a cationic surfactant.

11. The aqueous composition of claim 1, further comprising a viscosity enhancing water soluble polymer.

12. An emulsion composition comprising an unrefined petroleum, water, a surfactant, a boron oxygenate and a multivalent mineral cation.

13. The emulsion of claim 12, further comprising a co-solvent.

14. The emulsion of claim 12, wherein said emulsion is within a petroleum reservoir.

15. The emulsion of claim 12, wherein said emulsion has a pH of at least about 9.

16. The emulsion of claim 12, wherein said emulsion is in contact with a mineral, wherein water dissolves said multivalent mineral cation from said mineral.

17. The emulsion of claim 12, wherein said boron oxygenate is a metaborate or a borax.

18. The emulsion of claim 12, wherein said emulsion further comprises sodium silicate, potassium hydroxide or sodium hydroxide.

19. The emulsion of claim 12, further comprising a viscosity enhancing water soluble polymer.

20. A method of displacing an unrefined petroleum material in contact with a solid material, said method comprising:
(i) contacting an unrefined petroleum material with an aqueous composition as in claim 1, wherein said unrefined petroleum material is in contact with a solid material comprising a mineral, wherein water dissolves multivalent mineral cations from said mineral;
(ii) allowing said unrefined petroleum material to separate from said solid material thereby displacing said unrefined petroleum material in contact with said solid material.
